(19) United States
(12) Patent Application Publication
(10) Pub. No.: US 2026/0329006 A1
(43) Pub. Date: Oct. 22, 2026

(54) FREEFORM DIRECT-WRITE AND REWRITABLE PHOTONIC CIRCUITS ON PHASE-CHANGE THIN LAYERS

(71) Applicant: University of Washington, Seattle, WA (US)

(72) Inventors: Mo Li, Seattle, WA (US); Haoqin Deng, Seattle, WA (US); Changming Wu, Seattle, WA (US)

(73) Assignee: University of Washington, Seattle, WA (US)

(21) Appl. No.: 19/491,064

(22) PCT Filed: Jul. 12, 2024
(86) PCT No.: PCT/US2024/037914

§ 371 Date: Dec. 8, 2025

Related U.S. Application Data
(60) Provisional application No. 63/516,267, filed on Jul. 28, 2023.
(60) Provisional application No. 63/565,902, filed on Mar. 15, 2024.

(51) Int. Cl. G02B 6/13

(52) U.S. Cl. CPC G02B 6/13

(57) ABSTRACT

Photonic integrated circuits (PICs) systems and methods for writing PICs are described. In an embodiment, the PICs comprise a substrate; a phase-change material layer comprising a phase-change material disposed on the substrate, wherein the phase-change material comprises an amorphous phase subregion and a crystalline phase subregion; and an oxide layer coating the phase-change material layer. In an embodiment the phase-change material is configured to change phases between a crystalline phase and an amorphous phase upon illumination with light. In an embodiment, the phase-change material layer comprises a low-loss phase-change material layer.

### CROSS-REFERENCES TO RELATED APPLICATIONS

This application claims the benefit of and priority to U.S. Provisional Patent Application No. 63/516,267, filed Jul. 28, 2023, and U.S. Provisional Patent Application No. 63/565,902, filed Mar. 15, 2024, the contents of which are incorporated by reference herein in their entirety.

### STATEMENT OF GOVERNMENT LICENSE RIGHTS

This invention was made with Government support under Grant No. CCF-2105972, awarded by the National Science Foundation and Grant No. N00014-17-1-2661, awarded by the Office of Naval Research. The Government has certain rights in the invention.

### BACKGROUND

The application of photonic integrated circuits (PICs) is rapidly spreading in diverse technology domains, ranging from computing, communication, sensing, and quantum technology. Traditionally, PICs are fabricated in thin film materials, including silicon, silicon nitride, indium phosphide, and lithium niobates, using nanofabrication processes including lithography, etching, and deposition on tools installed in cleanroom facilities. Compared with electronics, where prototypes can be rapidly built by students using discrete elements plugged into a breadboard, photonics research faces the barriers of the limited accessibility to fabrication facilities, the high costs associated with the fabrication process, and the extended design-to-device turnaround time. The combination of these barriers impedes widespread innovation and throttles the broader impact of photonics research and education.

Moreover, there is a growing interest in programmable PICs to realize highly flexible photonic networks for emerging applications, including optical computing, optical interconnect for neural network accelerators, and quantum computing. Currently, programmable PICs are realized through a network of tunable components, including phase shifters, directional couplers, and interferometers, connected in a highly complex architecture. The programmability of those schemes has been limited to switching and rerouting the network, while freeform reconfiguration of the system's functionality remains difficult to achieve. As the complexity increases, programmable PICs face overwhelming challenges of scalability, programming precision, and flexibility, which limit their practicality and increase cost. Another challenge PICs face is the waste generated from malfunctioning dies and chips during the prototyping and testing stage, which are virtually impossible to repurpose once completed—a challenge that could be overcome using rewritable techniques.

### SUMMARY

To address these and related challenges, the present disclosure provides devices, systems, and methods capable of writing, erasing, and rewriting photonic circuits on phase change thin layers.

In an aspect, the present disclosure provides a device comprising an oxidized silicon substrate, such as a Si₃N₄ layer disposed on the oxidized silicon substrate, a phase-change material layer comprising a phase-change material disposed on the Si₃N₄ layer, wherein the phase-change material comprises an amorphous phase subregion and a crystalline phase subregion, and an oxide layer coating the phase-change material layer. In an embodiment, the phase-change material is configured to change phases between a crystalline phase and an amorphous phase upon illumination with light. In an embodiment, the phase-change material is Sb₂Se₃.

In an aspect, the present disclosure provides a system for writing, erasing, and rewriting a photonic integrated circuit on a phase-change thin layer. In an embodiment, the system includes a 2D motion stage and a light source that illuminates the phase-change material, thereby inducing a phase transition in the phase-change material layer. In an embodiment, the system is configured to write a photonic integrated circuit on the phase-change material. In an embodiment, the system is configured to erase a photonic integrated circuit on the phase-change material.

In an aspect, the present disclosure provides a method for writing photonic integrated circuits by selectively illuminating a photonic integrated circuit device, thereby inducing a phase change in a crystalline subregion to generate an amorphous subregion. In an embodiment, the method further comprises erasing photonic integrated circuits by selectively illuminating the photonic integrated circuit device with a light source.

In accordance with any embodiment of the present disclosure, the phase-change material is configured to change phases between a crystalline phase and an amorphous phase upon illumination with light.

In accordance with any embodiment of the present disclosure, the phase-change material layer comprises a low-loss phase-change material layer. In accordance with any embodiment of the present disclosure, the low-loss phase-change material layer comprises a material selected from the group consisting of Sb₂Se₃, Sb₂S₃, Sb₂TeₓSe₃₋ₓ, Ge₂Sb₂Te₅, and combinations thereof. In accordance with any embodiment of the present disclosure, the phase-change material layer comprises Sb₂Se₃.

In accordance with any embodiment of the present disclosure, the phase-change material further comprises a mixed-phase subregion.

In accordance with any embodiment of the present disclosure, the phase-change material does not comprise a mixed-phase subregion.

In accordance with any embodiment of the present disclosure, the system further comprises a grating coupler.

In accordance with any embodiment of the present disclosure, the amorphous phase and crystalline phase define a waveguide optical pathway.

In accordance with any embodiment of the present disclosure, moving, with the 2D motion stage, the device relative to the light source comprises moving the device relative to the light source at a speed in the range of about 0.1 mm/s to about 10 mm/s; and a power output of the light source is in the range of about 1 mW to about 10 W, thereby transitioning the phase-change material from a crystalline phase to an amorphous phase. In an embodiment, the speed is in the range of about 1 mm/s to about 1.5 mm/s; and a power output of the light source is in the range of about 25 mW to about 30 mW.

In accordance with any embodiment of the present disclosure, the light source has an output wavelength in the range of about 100 nm to about 1000 nm. In an embodiment, the light source power is switched on and off. In an embodiment, the light source is a laser.

In accordance with any embodiment of the present disclosure, moving, with the 2D motion stage, the device relative to the light source comprises moving the device relative to the light source at a speed in a range of about 0.1 mm/s to about 10 mm/s; and a power output of the light source is in the range of about 1 mW to about 10 W, thereby transitioning the phase-change material from an amorphous phase to a crystalline phase. In an embodiment, the speed is in the range of about 0.1 mm/s to about 0.25 mm/s; and a power output of the light source is in the range of about 10 mW to about 15 mW.

In accordance with any embodiment of the present disclosure, the system is configured to create one or more photonic devices, wherein the one or more photonic devices is selected from the group consisting of a grating coupler, a racetrack ring resonator, a Mach-Zehnder interferometer, a directional coupler, a multimode interference (MMI) device, a programmable optical interconnect fabric, a photonic crossbar array, a programmable mode demultiplexer, a programmable wavelength demultiplexer, a double injection ring filter, an inverse-designed waveguide bend, and combinations thereof.

In accordance with any embodiment of the present disclosure, the system further comprises a heat source configured to apply heat to the device, wherein the controller further includes logic that, when executed by the controller, causes the system to perform operations comprising: heating, with the heat source, the device at a temperature and for a time sufficient to induce a phase change in the amorphous phase subregion from the amorphous phase to the crystalline phase.

In an aspect, the present disclosure provides a multi-layer photonic integrated circuit (PIC) device comprising a three-dimensional (3D) stack of phase-change material layers, wherein each phase-change material layer comprises a phase-change material with an amorphous phase subregion and a crystalline phase subregion, a cladding material layer disposed between each of the phase-change material layers, a substrate upon which the 3D stack of phase-change material layers is disposed, and an oxide layer cap on the 3D stack of phase-change material layers.

In an aspect, the present disclosure provides a method for writing photonic integrated circuits comprising selectively illuminating a multi-layer PIC device, wherein the multi-layer PIC device comprises a 3D stack of phase-change material layers, wherein each phase-change material layer comprises a crystalline subregion, a cladding material layer disposed between each of the phase-change material layers, a substrate upon which the 3D stack of phase-change material layers is disposed, and an oxide layer cap on the 3D stack of phase-change material layers, thereby inducing a phase change within the crystalline subregion to generate an amorphous subregion.

In an aspect, the present disclosure provides a system for writing, erasing, and rewriting a photonic integrated circuit on a three-dimensional (3D) stack of phase-change thin layers. In an embodiment, the system includes a device comprising a three-dimensional (3D) stack of phase-change material layers, wherein each phase-change material layer comprises a phase-change material with an amorphous phase subregion and a crystalline phase subregion, a cladding material layer disposed between each of the phase-change material layers, a substrate upon which the 3D stack of phase-change material layers is disposed, and an oxide layer cap on the 3D stack of phase-change material layers, a light source configured to illuminate the device, a three-dimensional (3D) motion stage, wherein the device is disposed on the 3D motion stage, and wherein the 3D motion stage is configured to move the device relative to the light source, and a controller operatively coupled to the light source and the 3D motion stage, the controller including logic that, when executed by the controller, causes the system to perform operations comprising illuminating, with the light source, the phase-change material layer, and moving, with the 3D motion stage, the device relative to the light source, thereby selectively inducing a phase transition in the phase-change material layer.

In an aspect, the present disclosure provides a multi-layer meta-surface device comprising a three-dimensional (3D) stack of phase-change material layers, wherein each phase-change material layer comprises a phase-change material with a meta-surface comprising an amorphous phase subregion and a crystalline phase subregion, a cladding material layer disposed between each of the phase-change material layers, a substrate upon which the 3D stack of phase-change material layers is disposed, and an oxide layer cap on the 3D stack of phase-change material layers.

In accordance with any embodiment of the present disclosure, the substrate further comprises an optically transparent material, such as, but not limited to, oxidized silicon, glass, sapphire, or a semiconductor. In another embodiment, the substrate is not optically transparent.

In accordance with any embodiment of the present disclosure, at least two adjacent phase-change material layers are optically coupled.

In accordance with any embodiment of the present disclosure, at least two non-adjacent phase-change material layers are not optically coupled.

In accordance with any embodiment of the present disclosure, the meta-surface further comprises a meta-atom in a shape such as, but not limited to, a circle, square, rectangle, triangle, cross, or star.

In accordance with any embodiment of the present disclosure, the multi-layer meta-surface device further comprises an additional cladding material layer disposed between two adjacent phase-change material layers.

In an aspect, the present disclosure provides a method for writing multi-layer meta-optics comprising selectively illuminating a multi-layer meta-surface device, wherein the multi-layer meta-surface device comprises a three-dimensional (3D) stack of phase-change material layers, wherein each phase-change material layer comprises a phase-change material with a meta-surface comprising a crystalline subregion, a cladding material layer disposed between each of the phase-change material layers, a substrate upon which the 3D stack of phase-change material layers is disposed, and an oxide layer cap on the 3D stack of phase-change material layers, thereby inducing a phase change within the crystalline subregion of the meta-surface to generate an amorphous subregion.

In accordance with any embodiment of the present disclosure, the method further comprises scanning and modulating a laser to create meta-optics patterns in the phase-change material layer.

In an aspect, the present disclosure provides a system for writing, erasing, and rewriting meta-optics patterns in a three-dimensional (3D) stack of phase-change thin layers comprising a device comprising a three-dimensional (3D) stack of phase-change material layers, wherein each phase-change material layer comprises a phase-change material with a meta-surface comprising an amorphous phase subregion and a crystalline phase subregion, a cladding material layer disposed between each of the phase-change material layers, a substrate upon which the 3D stack of phase-change material layers is disposed, and an oxide layer cap on the 3D stack of phase-change material layers, a light source configured to illuminate the device, a three-dimensional (3D) motion stage, wherein the device is disposed on the 3D motion stage, and wherein the 3D motion stage is configured to move the device relative to the light source, and a controller operatively coupled to the light source and the 3D motion stage, the controller including logic that, when executed by the controller, causes the system to perform operations comprising illuminating, with the light source, the phase-change material layer, and moving, with the 3D motion stage, the device relative to the light source, thereby selectively inducing a phase transition in the phase-change material layer.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this the present disclosure will become more readily appreciated as the same become better understood by reference to the following detailed description, when taken in conjunction with the accompanying drawings, wherein:

FIG. 1A schematically illustrates freeform writing and rewriting PICs on Sb₂Se₃ thin film, according to embodiments of the present disclosure;

FIG. 1B is a cross-sectional view of a cSb₂Se₃ optical waveguide structure, where the waveguide is directly written in the PCM thin film without fabrication processes, according to embodiments of the present disclosure;

FIG. 1C illustrates a simulated |E|² profile of the TE₀ mode in a cSb₂Se₃ waveguide, which is 1.2-μm-wide, 30-nm-thick, sits on top of a 330-nm-thick Si₃N₄-on-insulator substrate, and is capped with a 200-nm-thick SiO₂ for protection, according to embodiments of the present disclosure;

FIG. 1D is an optical image of aSb₂Se₃ resolution test patterns written on cSb₂Se₃ thin film, where a minimum feature size achieved is 300 nm, according to embodiments of the present disclosure;

FIG. 1E is the test pattern as in from FIG. 1D erased back to cSb₂Se₃, according to embodiments of the present disclosure;

FIG. 2A is an optical image of a racetrack ring resonator that is directly written on the Sb₂Se₃ thin film, according to embodiments of the present disclosure;

FIGS. 2B and 2C provide zoomed-in optical images of the waveguide-ring coupling region (2B) and the grating coupler (2C), according to embodiments of the present disclosure;

FIG. 2D shows the transmission spectrum of the ring resonator is shown in FIG. 2A, where the spectrum is normalized to the spectrum of a pristine Sb₂Se₃ waveguide, and the intrinsic Q factor is 12,718, according to the embodiments of the present disclosure;

FIG. 2E is an optical image of a direct-write PCM Mach-Zehnder interferometer (MZI), wherein the inset shows a zoomed-in image of the Y-combiner part in the MZI, according to embodiments of the present disclosure;

FIG. 2F is a normalized transmission spectra of the MZIs, where spectra have been vertically offset for clarity, according to embodiments of the present disclosure;

FIG. 2G is a λ²/free-spectral-range vs. the length difference between two arms of the MZI, LL, where linear fitting yields the waveguide group index n_{g} to be 2.47, according to embodiments of the present disclosure;

FIGS. 3A-3C are optical images of a 3×3 optical switch array with the initial connection configuration (matrix 1) (3A), where the connection region of the optical switch is then erased (3B) and rewritten (3C) into a new connection configuration (matrix 2), according to embodiments of the present disclosure;

FIGS. 3D and 3E show the measured transmission matrix of switch 1 (3D) and switch 2 (3E), respectively, according to embodiments of the present disclosure;

FIG. 3F is an optical image of a DLW 14×14 crossbar array, where the inset shows the 3×3 sub-array used for testing, according to embodiments of the present disclosure;

FIGS. 3H and 3G show decreasing or increasing the transmission of a specific crossbar element from the array of FIG. 3F, where the cross-coupling waveguide is partially erased (3H) or recovered (3G), respectively, according to embodiments of the present disclosure;

FIGS. 3I-3L show the transmission matrix of the crossbar array of FIG. 3F after each configuration step, where the crossbar array is initially designed to equally distribute the input power into outputs, and due to writing imperfections, the transmission matrix of the crossbar array has errors (3I) and is corrected by DLW to restore the designed functionality (3J), (3K), and (3L), according to embodiments of the present disclosure; and the transmission matrix after setting the element at the center and four corners to 0 (3K) and then resetting the center matrix element to 0.5 (3L);

FIG. 4A is an MZI written by DLW on aSb₂Se₃ thin film, according to embodiments of the present disclosure;

FIG. 4B shows an erased part of the bottom arm of the MZI, according to embodiment of the present disclosure;

FIG. 4C adds a ring resonator to the erased region of the MZI, according to embodiment of the present disclosure;

FIG. 4D erases a part of the ring resonator and the MZI, according to embodiment of the present disclosure;

FIG. 4E reconnects the device as the double-injection ring (DIR) filter, according to embodiment of the present disclosure;

FIG. 4F tunes the coupling by increasing the gap between the ring resonator and the top arm of the Y-splitter, according to embodiment of the present disclosure;

FIG. 4G illustrates the transmission spectra of the optical filter after each reconfiguration step, respectively, where the spectra have been vertically translated for clarity, according to embodiment of the present disclosure;

FIG. 4H shows the transmission spectra of the double-injection ring filter before (top curve) and after (bottom curve) tuning the ring resonator coupling, according to embodiment of the present disclosure;

FIG. 5A is a cross-sectional schematic of the programmable Sb₂Se₃-based MMI structure, according to embodiment of the present disclosure;

FIGS. 5B and 5C are inverse-design binarized Sb₂Se₃ phase pattern for the (5B) mode and (5C) wavelength demultiplexer, according to embodiment of the present disclosure, where white and black areas indicate the crystalline and amorphous Sb₂Se₃ respectively

FIGS. 5D and 5E are simulated transmission spectrum of the mode demultiplexer as the (5D) TE₀ and (5E) TE₁ modes are incident, where the corresponding Sb₂Se₃ phase pattern is shown in (B), and the inset: The E|² distribution when TE₀ mode and TE₁ mode are input to the MMI respectively, according to embodiment of the present disclosure;

FIG. 5F is a simulated transmission spectrum of the wavelength demultiplexer, where the corresponding Sb₂Se₃ phase pattern is shown in (5C), according to embodiment of the present disclosure.

FIG. 6A is an optical image of aSb₂Se₃ rectangular with different sizes written on a 30 nm-thick cSb₂Se₃-on-Si₃N₄ sample, where the minimum feature size of the optical patterning is 300 nm, where the sample is encapsulated by a layer of 200 nm thick Al₂O₃, according to embodiment of the present disclosure;

FIG. 6B is an optical image of the same sample as shown in FIG. 6A after the pattern is erased through thermal annealing, according to embodiment of the present disclosure;

FIG. 6C is schematic illustration of an MMI device programmed as a mode demultiplexer, according to embodiment of the present disclosure;

FIGS. 6D and 6E are transmission spectra of the mode demultiplexer shown in FIG. 6C with the (6D) TE₀ and (6E) TE₁ modes as the input, according to embodiment of the present disclosure;

FIG. 7A is an illustration of programming a Sb₂Se₃ thin film integrated MMI using a focused laser beam, where direct laser writing system is used to write/erase various phase patterns onto the Sb₂Se₃ thin film, which determines the function of the MMI, according to embodiment of the present disclosure;

FIG. 7B is a top-view optical image of an as-fabricated 40×8 μm² MMI, where the device's functionality is defined by the Sb₂Se₃ phase pattern in the “inverse design region” (dashed box), according to embodiment of the present disclosure;

FIG. 7C is a cross-sectional schematic of the MMI device with patterned Sb₂Se₃ to change the function of the device, the phase pattern in the Sb₂Se₃ thin film is recreated, while all the other components remain unchanged, according to embodiment of the present disclosure;

FIG. 8A is a schematic of the inverse design approach to generate phase pattern for the Sb₂Se₃ MMI, where optimization is initiated with a fully crystalline Sb₂Se₃ thin film, and then the amorphous-crystalline spatial distribution is inverse-designed using the topology optimization method, resulting in a binary phase pattern, and white and black areas indicate the crystalline and amorphous Sb₂Se₃, respectively, according to embodiment of the present disclosure;

FIG. 8B is an optical image of aSb₂Se₃ rectangular array written on cSb₂Se₃ thin film for testing the writing resolution where a minimum feature size achieved is 300 nm, according to embodiment of the present disclosure;

FIG. 8C is a test pattern in FIG. 8B is erased back to the cSb₂Se₃ phase by thermal annealing, where the area marked by dashed lines indicates the initial patterns, according to embodiment of the present disclosure;

FIG. 8D provides optical images of an inverse-designed pattern for the mode demultiplexer written in Sb₂Se₃, according to embodiment of the present disclosure;

FIG. 8E provides the corresponding inverse designed, binarized Sb₂Se₃ phase pattern for the mode demultiplexer, according to embodiment of the present disclosure;

FIG. 9A illustrates an optical setup for the MDM device measurement comprising an optical switch and a mode combiner control the input mode, TE₀ or TE₁, to the MDM, where the inset shows the optical image of the mode combiner, according to embodiment of the present disclosure;

FIGS. 9B and 9C show simulated |E|² distribution in the MDM with TE₀ mode input (9B) and TE₁ mode input (9C) at the wavelength of 1550 nm, according to embodiment of the present disclosure;

FIGS. 9D and 9E show simulated (left column) and measured (right column) transmission spectrum of the mode demultiplexer when the TE₀ mode (9D) or TE₁ mode (9E) is input, where the lower extinction ratio is attributed to fabrication imperfections and laser writing misalignment, according to embodiment of the present disclosure;

FIG. 10A-10C are optical images showing the steps that the MDM device (10A) is first erased to the full crystalline cSb₂Se₃ thin film (10B) and then reprogrammed as a WDM (10C), according to embodiment of the present disclosure;

FIG. 10D illustrates inverse-design binarized Sb₂Se₃ phase pattern for the WDM, where white and black areas indicate the crystalline and amorphous Sb₂Se₃, respectively, according to embodiment of the present disclosure;

FIGS. 10E and 10F show simulated |E|² distribution of the WDM device operating at 1475 nm (10E) and 1625 nm (10F), according to embodiment of the present disclosure;

FIGS. 10G and 10H show transmission spectra to output ports 2 and 3 obtained from simulation (10G) and measurement (10H), according to embodiment of the present disclosure;

FIG. 11A schematically illustrates laser writing in multilayers of PCM spaced by a spacer layer, where each layer can be separately written by focusing the laser onto it, and layers out of the focus will not be affected, according to embodiment of the present disclosure;

FIG. 11B shows PICs in the PCM created by turning the PCM (Sb₂Se₃ for example) from crystalline to amorphous phase, where the waveguides in adjacent layers can be evanescently coupled to route optical signals from layer to layer, according to embodiment of the present disclosure;

FIG. 12 shows interlayer coupling using grating couplers patterned in the PCM layer, according to embodiment of the present disclosure;

FIG. 13 illustrates application of multiple PCM PICs as optical interposers for system-on-chip with multiple chipsets, according to embodiment of the present disclosure;

FIG. 14 illustrates multilayers of PCM meta-surfaces can be laser direct written to realize meta-optics, such that it can used for transmission or reflection modes, according to embodiment of the present disclosure;

FIGS. 15A and 15B schematically illustrate laser direct writing in multilayers of PCM and cladding materials (15A), where (15B) the vertical separation between the patterned PCM layers determines if the meta-atoms are local (uncoupled) or non-local (coupled between layers), according to embodiment of the present disclosure; and

FIGS. 16A and 16B provide an example of multilayer meta-optics design (16A) according to embodiments of the present disclosure; in which each meta-atom (16B) is a circular disk, where the design parameters include the radius (r) of each disk and the spacing (p) between each disk; and

FIG. 16C provides a simulated phase shift of transmitted light at 1550 nm wavelength of the meta-optics design of FIG. 16A, which can be varied from 0 to 2*pi when the radius r is changed from 0 to 0.5 μm, according to embodiments of the present disclosure.

### DETAILED DESCRIPTION

In the present disclosure, a fast turnaround and low-cost approach to creating and reprogramming PICs that could shift the paradigm in photonics research, prototyping, and education is described. By eliminating the reliance on traditional fabrication processes, a wider space of design possibilities and system functionalities are rapidly developable. Moreover, such a technique allows researchers and students who do not have access to nanofabrication facilities to prototype and reuse PIC designs, and thus democratize photonics research to a broader community. It enables more students and educators to engage in hands-on experimentation, thereby fostering innovation and knowledge dissemination and generating a broader impact to promote workforce development in photonics.

In an embodiment, the present disclosure describes a technique based on direct laser writing (DLW) on phase-change material (PCM) thin films. In an embodiment, the method writes the PICs in only one optical patterning step and without using any traditional lithography and etching processes. In an embodiment, the PICs are created by utilizing PCM's dramatic refractive index contrast between the two nonvolatile phases, amorphous and crystalline, which are reversibly switchable using optical pulses. Direct writing of functional PICs including a full package of building-block photonic components, including waveguides, gratings, ring resonators, couplers, crossings, and interferometers, are described. Remarkably, these direct-write PICs are also rewritable, allowing convenient erasure and rewriting of the circuits either partially or entirely, thereby completely changing their functionality to suit very different application scenarios.

Previously, laser writing to control phase transition in PCMs has been used in optical storage, such as rewritable compact disks (CD-RW). Free-space optical switching of PCMs has also been used to realize reconfigurable metasurface, rewritable color displays, and polariton nanophotonic devices. Laser patterning of photonic circuits has been reported, including femtosecond laser writing of waveguides in glass and a programmable III-V semiconductor-based photonic device. However, laser writing of glass waveguides is a non-reversible process, whereas the optical patterning in III-V semiconductors is volatile, requiring continuous laser irradiation to sustain. Additionally, none of the above techniques creates complete end-to-end PIC systems with multiple reconfigurable functions, as described herein.

Accordingly, in an aspect, the present disclosure provides a photonic integrated circuit (PIC) comprising phase-change material layers configured to and otherwise capable of being written, erased, and rewritten. In this regard, in an embodiment, the PIC comprises a substrate; a phase-change material layer comprising a phase-change material disposed on the substrate, wherein the phase-change material comprises an amorphous phase subregion and a crystalline phase subregion; and an oxide layer coating the phase-change material layer. As described further herein, in an embodiment, the phase-change material is configured to change phases between a crystalline phase and an amorphous phase upon illumination with light. In an embodiment, the change between crystalline and amorphous phases is reversible, such that the phase-change material can be transitioned between, for example, crystalline and amorphous phases and back to a crystalline phase, such as through repeated exposure to light, heat, combinations thereof, or other forms of energy.

In an embodiment, the phase-change material layer comprises a low-loss phase-change material layer, such as a phase-change material that is configured to transmit light with low levels of optical loss, such as through scattering of light travelling through the phase-change material. In an embodiment, the phase-change material layer comprises a material selected from the group consisting of Ge₂Sb₂Te₅, Sb₂S₃, Sb₂TeₓSe₃₋ₓ, and combinations thereof, wherein x is in a range of 0-3. In an embodiment, the phase-change material layer comprises Sb₂Se₃.

In accordance with any embodiment of the present disclosure, the substrate further comprises an optically transparent material, such as, but not limited to, oxidized silicon, glass, sapphire, or a semiconductor. In another embodiment, the substrate is not optically transparent. An optically transparent substrate allows for light to pass through the substrate, such as to write or erase a pattern in the phase-change material layer by manipulating crystalline and amorphous subregions therein.

In an embodiment, the substrate comprises an oxidized silicon substrate; and a Si₃N₄ layer disposed on the oxidized silicon substrate. While such a substrate is described further herein with respect to certain examples, it will be understood that other substrate materials and configurations are possible and within the scope of the present disclosure.

In an embodiment, the phase-change material further comprises a mixed-phase subregion. In this regard, the phase-change material layer comprises subregions comprising both crystalline and amorphous phases of the phase-change material.

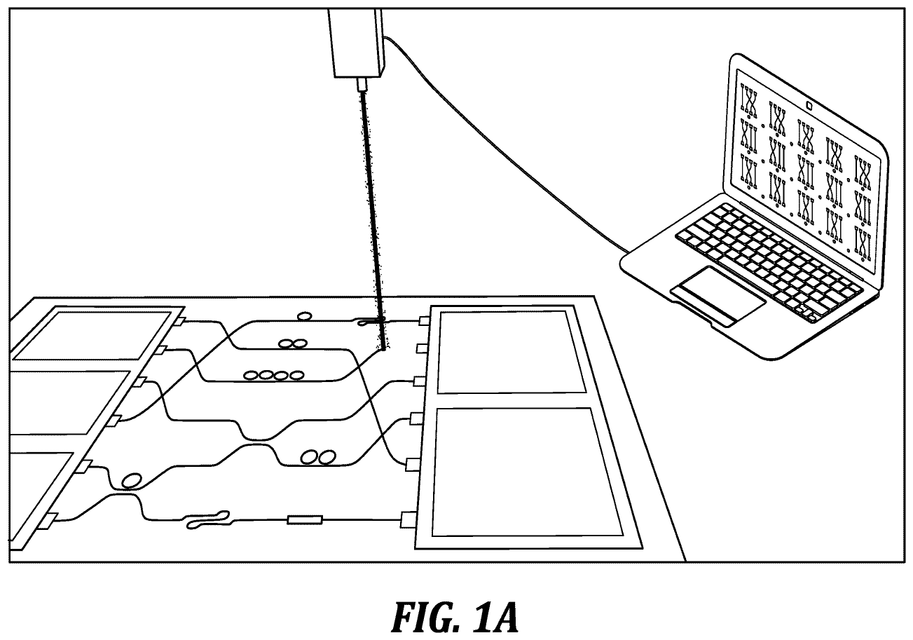

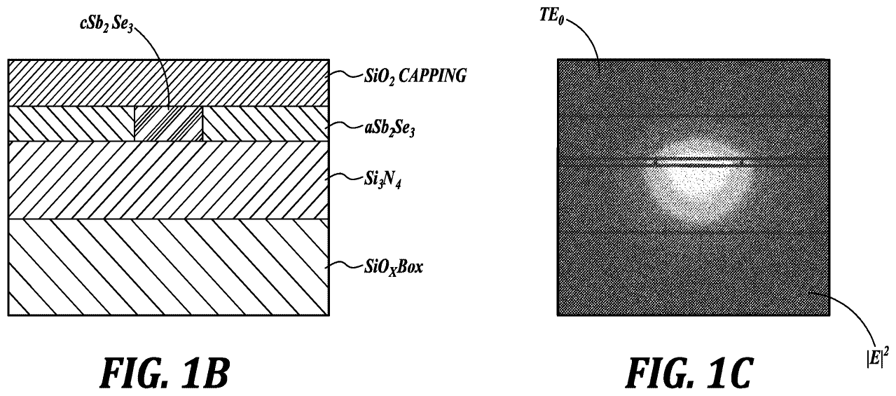

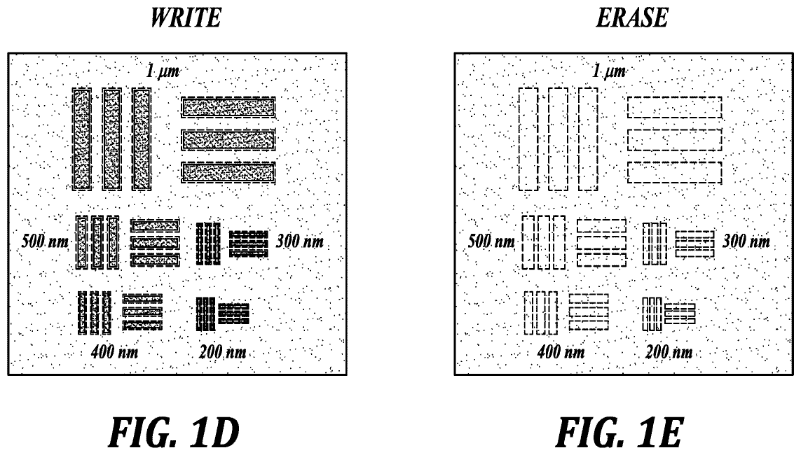

However, in other embodiments, the phase-change material does not comprise a mixed-phase subregion. As discussed further herein, without being bound by theory, this binary phase configuration—that is, no mixed phases—enables the confinement of the fundamental transverse electric (TE₀) optical mode within a cSb₂Se₃ waveguide, assisted by the underlayer of Si₃N₄, as shown in the simulated mode profile in FIG. 1C.

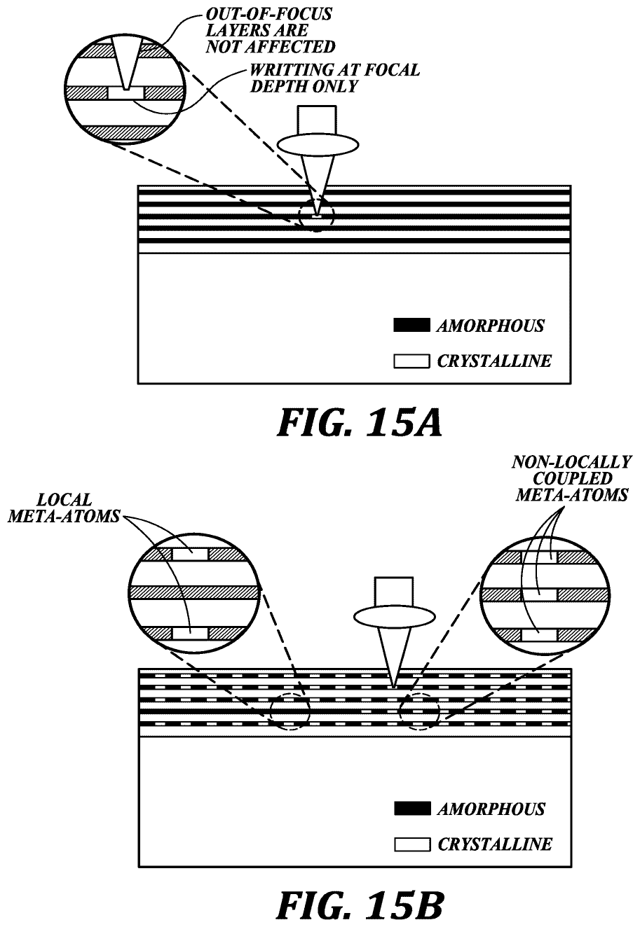

In an embodiment, the phase-change material layer is one of a plurality of phase-change material layers disposed in a stack of phase-change material layers, such as is illustrated in FIGS. 15A and 15B, and discussed further herein with respect to Example 9. In an embodiment, each phase-change material layer of the plurality of phase-change material layers comprises an amorphous phase subregion and a crystalline phase subregion. In an embodiment, the crystalline and amorphous subregions within each of the phase-change material layer define optical pathways, such as optical waveguides, diffractive structures, or other optical pathways.

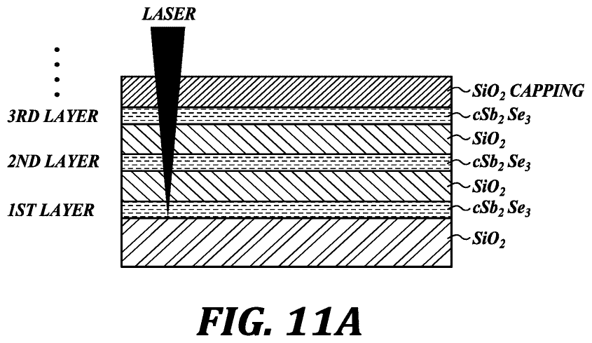

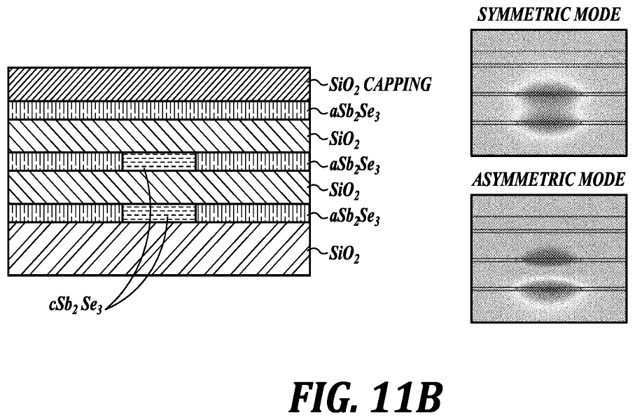

In an embodiment, the PIC further comprises a cladding material layer disposed between each phase-change material layer of the plurality of phase-change material layers. As illustrated in FIGS. 11A and 111B, such cladding material can comprise a silicon oxide layer disposed between adjacent phase-change material layers.

As discussed further herein, by focusing light, for example, on particular phase-change material layers, a phase of the phase-change material layer within the stack of phase-change material layers can be altered, such as to define optical pathways within individual phase-change material layers of the stack.

In an embodiment, at least two adjacent phase-change material layers of the plurality of phase-change material layers are optically coupled. In this regard, light passing through one of the phase-change material layers can be affected, such as in direction, by another phase-change material layer. For example, such coupling can cause light to be diffracted as it passes through the stack of phase-change material layers. In an embodiment, the amorphous phase and crystalline phase define a diffractive optical pathway.

As discussed further herein, such optical coupling is generally proportional to distance between phase-change material layers. Accordingly, in an embodiment, at least two nonadjacent phase-change material layers of the plurality of phase-change material layers are not optically coupled, due a distance between the two nonadjacent phase-change material layers.

In another aspect, the present disclosure provides a system for creating PICs. In an embodiment, the system comprises a PIC device, such as described further herein, a light source configured to illuminate the PIC device, and a stage or other device configured to move the PIC device relative to the light source.

As described further herein, in an embodiment, the PIC device comprises a substrate; a phase-change material layer disposed on the substrate, wherein the phase-change material comprises an amorphous phase subregion and a crystalline phase subregion; and an oxide layer coating the phase-change material layer.

As above, in an embodiment, the system comprises a light source configured to illuminate the PIC device. In an embodiment, light source is configured to emit light at a wavelength and/or at an intensity configured to transition the phase-change material of the PIC device from a crystalline phase to an amorphous phase. In an embodiment, light source is configured to emit light at a wavelength and/or at an intensity configured to transition the phase-change material of the PIC device from an amorphous phase to a crystalline phase. While wavelength, intensity, and time sufficient to effect phase change within the phase-change material will be dependent upon a number of variables, including material, layer thickness, ambient temperature, etc., one of skill in the art will understand how to adjust these variables to achieve desired phase change.

In an embodiment, the light source comprises a coherent light source configured to emit coherent light. In an embodiment, the light source comprises or is a laser.

As also above, in an embodiment, the system comprises a stage. In an embodiment, the stage is a two-dimensional (2D) motion stage. In an embodiment, the PIC device is disposed on the 2D motion stage. In an embodiment, the 2D motion stage is configured to move the PIC device relative to the light source. In this regard, as the 2D motion stage moves, the system is configured to expose various portions of the PIC device, and, in particular, the phase-change material layer, to light from the light source.

In an embodiment, the system comprises a controller, such as a controller operatively coupled to various system components to choreograph their operation and exchange signals therebetween. In an embodiment, the controller a computer system (e.g., one or more processors coupled with memory), an application specific integrated circuit (ASIC), a field-programmable gate array, or the like, configured to coordinate and/or control, at least in part, operations of the system. Stored on controller (e.g., on the memory coupled with controller or as application specific logic and associated circuitry) are instructions that, when executed by controller, perform one or more or a portion of methods of the present disclosure.

In particular, a controller can include instructions (e.g., stored on memory) or logic (e.g., an application specific integrated circuit) for performing methods of the present disclosure. Additionally, or alternatively, such methods can be implemented as instructions stored on any form of a non-transitory machine-readable storage medium. In some embodiments, one or more of operations the methods of the present disclosure can be omitted, repeated, reordered, or executed concurrently (e.g., by parallelization), rather than in sequence as illustrated.

In an embodiment, such operations comprise illuminating, with the light source, the phase-change material layer; and moving, with the 2D motion stage, the PIC device relative to the light source, thereby selectively inducing a phase transition in the phase-change material layer.

In an embodiment, wherein moving, with the 2D motion stage, the PIC device relative to the light source comprises moving the PIC device relative to the light source at a speed in a range of about 0.1 mm/s to about 10 mm/s, wherein a power output of the light source is in the range of about 1 mW to about 10 W, thereby transitioning the phase-change material from a crystalline phase to an amorphous phase.

In an embodiment, wherein moving, with the 2D motion stage, the PIC device relative to the light source comprises moving the device relative to the light source at a speed in a range of about 0.1 mm/s to about 10 mm/s; and wherein a power output of the light source is in the range of about 1 mW to about 10 W, thereby transitioning the phase-change material from an amorphous phase to a crystalline phase.

In an embodiment, the light source has an output wavelength in the range of about 100 nm to about 1000 nm.

As described further herein, light intensity, scan speed, etc. are variables that can affect whether and how the phase-change material transitions from one phase to another (i.e., from crystalline to amorphous, or amorphous to crystalline). The light intensities and scan speeds above are examples, and one of skill in the art is able to determine what scan speeds, light intensities, wavelengths, etc. are appropriate for a given scenario in view of the teachings of the present disclosure.

As above, the 2D stage, in conjunction with the light source, as choreographed by the controller, is configured to generate in the phase-change material crystalline and amorphous subregions, thereby, in certain embodiments, also creating light guiding or other optical structures. In this regard, in an embodiment, system is configured to create one or more photonic device. In an embodiment, the system is configured to create one or more photonic devices, wherein the one or more photonic devices is selected from the group consisting of a grating coupler, racetrack ring resonator, a Mach-Zehnder interferometer, a directional coupler, a multimode interference (MMI) device, a programmable optical interconnect fabric, a photonic crossbar array, a programmable mode demultiplexer, a programmable wavelength demultiplexer, a double injection ring filter, an inverse-designed waveguide bend, and combinations thereof.

As discussed further herein, heating the phase-change material can cause portions of the phase-change material to transition from one phase to another. In an embodiment, effecting such phase change can be achieved using light, such as with the light source. In an embodiment, however, the system further comprises a heat source configured to apply heat to the PIC device. In an embodiment, the controller further includes logic that, when executed by the controller, causes the system to perform operations comprising heating, with the heat source, the PIC device at a temperature and for a time sufficient to induce a phase change in the amorphous phase subregion from the amorphous phase to the crystalline phase. In an embodiment, the heat source is configured to generally heat the phase-change material layer, such as where the heat source is disposed in the substrate, such as where the heat source is configured to generally erase a previous PIC in the PIC device. In an embodiment, the heat source is configured to selectively heat the phase-change material, such as with an integrated heater tip, such as to selectively modify the phase-change material layer.

As discussed elsewhere herein, in an embodiment, the phase-change material layer is one of a plurality of phase-change material layers disposed in a stack of phase-change material layers. In an embodiment, each phase-change material layer of the plurality of phase-change material layers comprises an amorphous phase subregion and a crystalline phase subregion. In an embodiment, there is a cladding material layer disposed between each phase-change material layer of the plurality of phase-change material layers.

In an embodiment, at least two adjacent phase-change material layers of the plurality of phase-change material layers are optically coupled, such as due to relatively close proximity of the adjacent phase-change material layers. Conversely, in an embodiment, at least two nonadjacent phase-change material layers of the plurality of phase-change material layers are not optically coupled.

In an embodiment, the system is configured to write optical waveguide or diffractive pathways in the plurality of phase-change material layers. Accordingly, in an embodiment, the controller further comprises logic that, when executed by the controller, causes the system to perform operations comprising selectively illuminating a first phase-change material layer of the plurality of phase-change material layers. In an embodiment, such operations further include not illuminating a second phase-change material layer of the plurality of phase-change material layers, thereby selectively inducing a phase transition in the first phase-change material layer.

In an embodiment, the system comprises a lens or other optical component or set of optical components configured to focus light selectively on one phase-change material layer of the plurality of phase-change material layers. In an embodiment lens or other optical component(s) is/are configured to change focal length such that the system is configured to illuminate a first phase-change material layer and then, upon changing focal length, illuminate a second phase-change material layer.

In an embodiment, the PIC device further comprises a grating coupler configured to receive light from the light source. In this regard, in an embodiment, the PIC device is configured to couple light into the PIC device from an external light source.

The processes explained above are described in terms of computer software and hardware. The techniques described can constitute machine-executable instructions embodied within a tangible or non-transitory machine (e.g., computer) readable storage medium, that when executed by a machine (e.g., controller) will cause the machine to perform the operations described. Additionally, the processes can be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

In another aspect, the present disclosure provides a method, such as a method for writing PICs. In an embodiment, the method can be performed using a system according to any embodiment of the present disclosure. In an embodiment, the method is suitable to provide a PIC according to any embodiment of the present disclosure.

In an embodiment, the method comprises selectively illuminating a PIC device, such as a PIC device as described elsewhere herein, and, in particular, a phase-change material layer of the PIC device, to induce a phase change in the phase-change material layer.

In an embodiment, the phase-change material layer comprises a crystalline subregion. In an embodiment, illuminating the phase-change material layer generates an amorphous subregion, such as by converting all or a portion of the crystalline subregion to an amorphous phase.

In an embodiment, the phase-change material layer comprises an amorphous subregion. In an embodiment, illuminating the phase-change material layer generates a crystalline subregion, such as by converting all or a portion of the amorphous subregion to a crystalline phase.

In an embodiment, the PIC device comprises a substrate; a phase-change material layer disposed on the substrate, wherein the phase-change material comprises a crystalline phase subregion; and an oxide layer coating the phase-change material layer.

In an embodiment, the phase-change material layer comprises a low-loss phase-change material layer. In an embodiment, the phase-change material layer comprises a material selected from the group consisting of Ge₂Sb₂Te₅, Sb₂S₃, Sb₂TeₓSe₃₋ₓ, and combinations thereof, wherein x is in a range of 0-3. In an embodiment, the phase-change material layer comprises Sb₂Se₃.

In an embodiment, the substrate comprises an optically transparent material. In an embodiment, the substrate comprises an oxidized silicon substrate; and a Si₃N₄ layer disposed on the oxidized silicon substrate.

Various metrics associated with illuminating the phase-change material layer can be adapted to determine or otherwise influence a phase (e.g., crystalline or amorphous) of the phase-change material.

For example, where a phase-change material starts in a crystalline phase, higher illumination intensities and faster write speeds can be used to transition the phase-change material to an amorphous phase. Higher light intensities can tend to transition the phase-change material into a disordered (i.e., amorphous) state. With higher write speeds (i.e., moving the focused light more quickly away from the now disordered phase-change material), the phase-change material will quench (i.e., cool quickly) and remain in the amorphous phase.

Conversely, to transition a phase-change material from a crystalline phase to an amorphous phase, generally lower light intensities and slower write speeds can be used. In this regard, slower heating of the phase-change material allows the phase-change material to slowly cool, thereby allowing crystalline subregions to form.

It will be understood that write speeds and light intensities will be dependent upon a number of factors including, but not limited to, phase-change material, illumination light wavelength range, phase-change material thickness, ambient temperature, etc. It will be further understood that one of skill in the art will be able to determine write speed and light intensity suitable to transition a particular phase-change material layer from one phase to another with the description in the present disclosure.

As described elsewhere herein, in an embodiment, the phase-change material layer is moved relative to a light source with a motion stage, such as a 2D motion stage.

In an embodiment, moving, with the 2D motion stage, the device relative to the light source comprises moving the device relative to the light source at a speed in the range of about 0.1 mm/s to about 10 mm/s; and a power output of the light source is in the range of about 1 mW to about 10 W, thereby transitioning the phase-change material from a crystalline phase to an amorphous phase. In an embodiment, the speed is in the range of about 1 mm/s to about 1.5 mm/s; and a power output of the light source is in the range of about 25 mW to about 30 mW.

In an embodiment, the light source has an output wavelength in the range of about 100 nm to about 1000 nm. In an embodiment, the light source power is switched on and off. In an embodiment, the light source is a laser.

In an embodiment, the method comprises erasing photonic integrated circuits by selectively illuminating the PIC device comprising an amorphous phase subregion, thereby inducing a phase change within the amorphous subregion to generate a crystalline subregion.

In an embodiment, moving, with the 2D motion stage, the device relative to the light source comprises moving the device relative to the light source at a speed in a range of about 0.1 mm/s to about 10 mm/s; and a power output of the light source is in the range of about 1 mW to about 10 W, thereby transitioning the phase-change material from an amorphous phase to a crystalline phase. In an embodiment, the speed is in the range of about 0.1 mm/s to about 0.25 mm/s; and a power output of the light source is in the range of about 10 mW to about 15 mW.

As discussed elsewhere herein, in an embodiment, the phase-change material layer is one of a plurality of phase-change material layers disposed in a stack of phase-change material layers. In an embodiment, the method further selectively illuminating a first phase-change material layer of the plurality of phase-change material layers and not a second phase-change material layer of the plurality of phase-change material layers, thereby selectively inducing a phase transition in the first phase-change material layer. As discussed elsewhere herein, selectively illuminating particular phase-change material layers of the plurality of phase-change material layer can be suitable to provide, for example, optically diffractive pathways through the plurality of phase-change material layers.

### EXAMPLE 1: DIRECT-WRITE AND REWRITABLE PICS

In an embodiment, FIG. 1A illustrates the concept of direct writing, erasing, and rewriting PICs. The PIC is written on a standard oxidized silicon substrate, which is coated with a 200-nm-thick SiO₂ layer covering a 30-nm-thick Sb₂Se₃ layer on a 330-nm-thick Si₃N₄ film. The SiO₂ capping layer protects and prevents oxidation of the Sb₂Se₃ layer. In an embodiment, waveguiding in the Sb₂Se₃ film is achieved by using the crystalline phase (cSb₂Se₃) as the high-index core and the amorphous phase (aSb₂Se₃) as the cladding (FIG. 1B). Without being bound by theory, this binary phase configuration—that is, no mixed phases—enables the confinement of the fundamental transverse electric (TE₀) optical mode within a cSb₂Se₃ waveguide, assisted by the underlayer of Si₃N₄, as shown in the simulated mode profile in FIG. 1C. In an embodiment, the circuit layout is directly written on a blank cSb₂Se₃ thin film using a commercial laser writing system (Heidelberg DWL 66+, 405 nm laser), mainly to leverage its precision stage and computer control system for large area writing. Alternatively, in an embodiment, a homebuilt system using an off-the-shelf laser diode is sufficient to write a smaller area. While a commercial laser writing system and a homebuilt system using an off-the-shelf laser diode is described, it will be understood that any light source can be used in the device, systems, and methods described in the present disclosure. It will be further understood that, while certain embodiments may be described with respect to or using a commercial laser writing system or a homebuilt system using an off-the-shelf laser diode, all light sources fall within the scope of the present disclosure.

In an embodiment, to write the PICs, a focused laser beam with a power of 27.5 mW is scanned across the film at a speed of 3.0 mm²/min, inducing a controlled phase transition from cSb₂Se₃ to aSb₂Se₃ to create the claddings and define the core. This laser-controlled phase transition creates a circuit with a resolution limited by optical diffraction. In an embodiment, FIG. 1D shows a series of rectangular aSb₂Se₃ structures created by DLW with varying widths ranging from 1 μm to 200 nm. The minimum achievable feature size is 300 nm, exceeding the resolution reported in previous works. Moreover, in an embodiment, the circuit layout can be erased either locally or globally. In an embodiment, local erasure is achieved by scanning the laser beam at a lower speed (0.1 mm²/min) with a reduced laser power of 15 mW, inducing a phase transition from aSb₂Se₃ back to cSb₂Se₃ in desired areas (FIG. 1E). This capability enables modifications and corrections to the PIC design. Alternatively, in an embodiment, global erasure can be accomplished by heating the whole substrate to above 180 C, promoting a complete phase transition across the entire PCM film. Thereby, the DLW technique provides very versatile capabilities for writing and rewriting phase-change PICs in freeform without using any advanced fabrication tools.

### EXAMPLE 2: DIRECT-WRITE PIC COMPONENTS

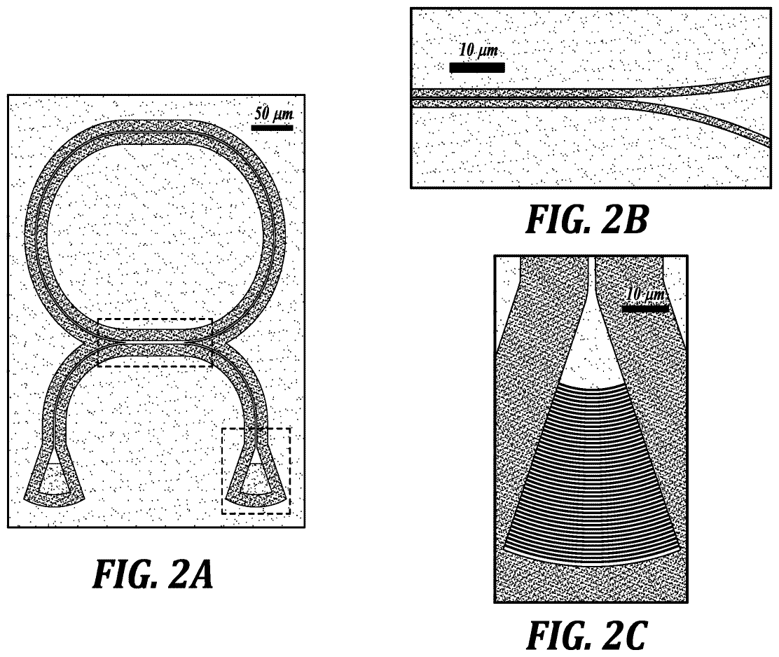

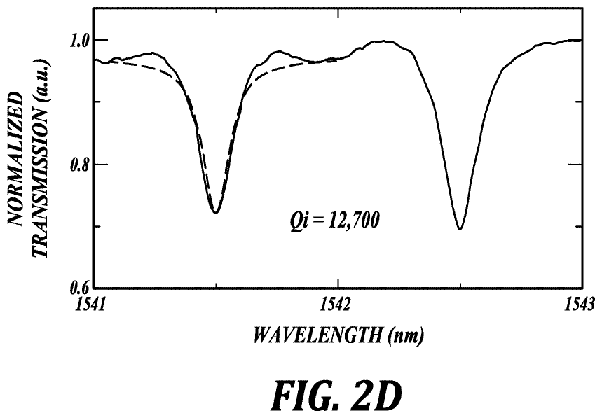

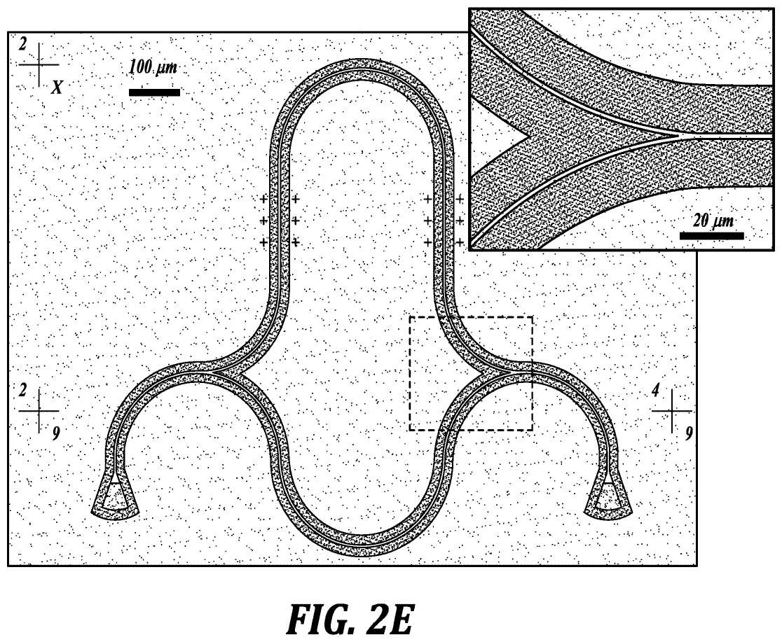

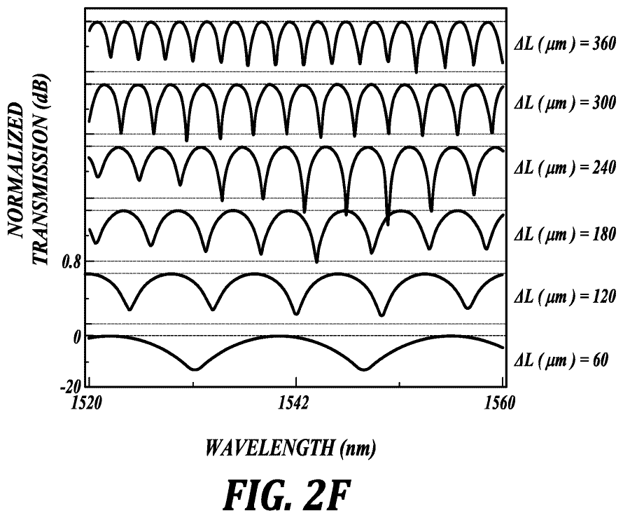

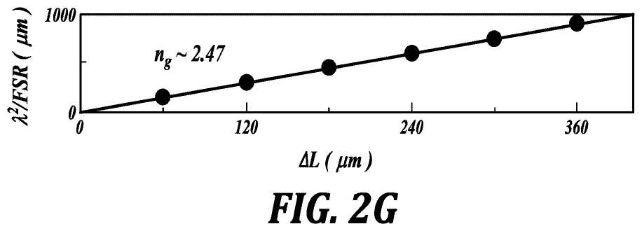

in an embodiment, high-quality building-block components of PICs are created by DLW. In an embodiment, FIG. 2A depicts a racetrack ring resonator coupled with a bus waveguide connected to input and output grating couplers, all directly written with DLW. The resonator has a width of 1.2 μm and a radius of 120 μm with a gap of 350 nm to the bus waveguide (FIG. 2B). In an embodiment, the pair of grating couplers couple light from optical fibers into the bus waveguide (FIG. 2C) with an efficiency of −14 dB. In an embodiment, FIG. 2D shows the measured transmission spectrum through the bus waveguide, showing the resonances of the ring resonator with an intrinsic quality factor is Qi~12,700, corresponding to a propagation loss of 2.8 dB mm⁻¹. Without being bound by theory, the loss in the cSb₂Se₃ waveguide is mainly attributed to the scattering induced by the grain boundaries in the waveguide, as in-plane crystalline grains within the cSb₂Se₃ region can be observed with high-resolution electron microscopy. These grains, typically a few microns in size, are also randomly oriented. Because of the optical birefringence of cSb₂Se₃, these randomly oriented grains result in the uneven absorption of laser energy during the DLW and limit the smoothness of the waveguide. In an embodiment, the scattering loss is mitigated when a lower erasure temperature is used to form larger crystal grains with sizes on the order of tens of microns. Further mitigation of the loss will require improved optical phase-change materials with finer polycrystalline structures. Nevertheless, the propagation loss of the cSb₂Se₃ waveguide is consistent with the reported values of dielectric waveguides integrated with Sb₂Se₃.

In an embodiment, the devices written on phase-change thin film exhibit consistent and reliable performance. To demonstrate this, in an embodiment, multiple Mach-Zehnder interferometers (MZIs) were written with varied path length differences, LL, between the two arms (FIG. 2E). The corresponding measured transmission spectrum is shown in FIG. 2F, FIG. 2G is a λ²/free-spectral-range vs. the length difference between two arms of the MZI, LL, where linear fitting yields the waveguide group index n_{g} to be 2.47, according to embodiments of the present disclosure. The consistently high extinction ratio (>20 dB) indicates the 50/50 beam splitters (inset, FIG. 2E) performs very well. Fitting the spectra, a group index ng=2.47 for a 1.2-μm-wide Sb₂Se₃ waveguide is extracted, which agrees well with the simulated value of 2.43.

### EXAMPLE 3: PROGRAMMABLE INTERCONNECT FABRIC AND CROSSBAR MATRIX

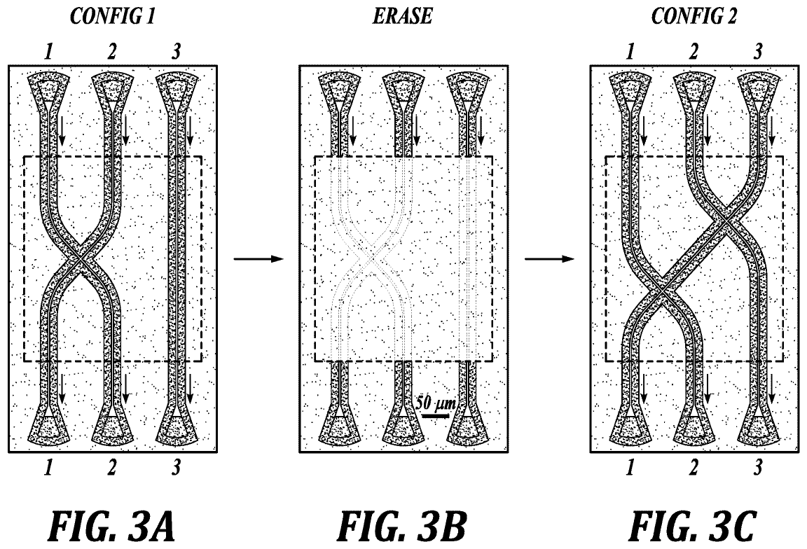

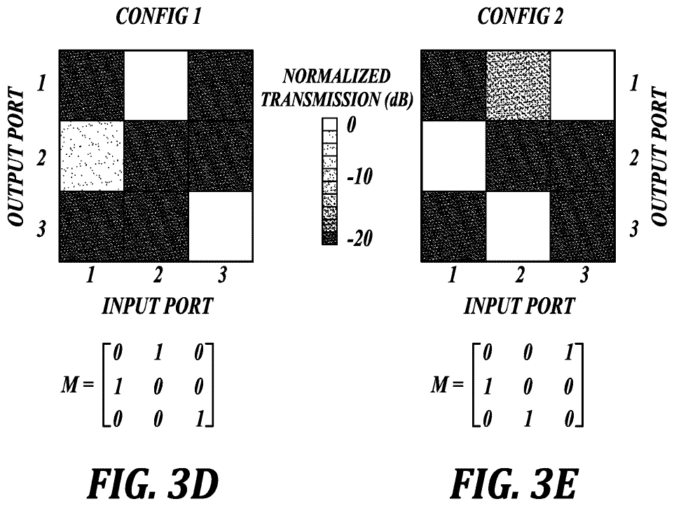

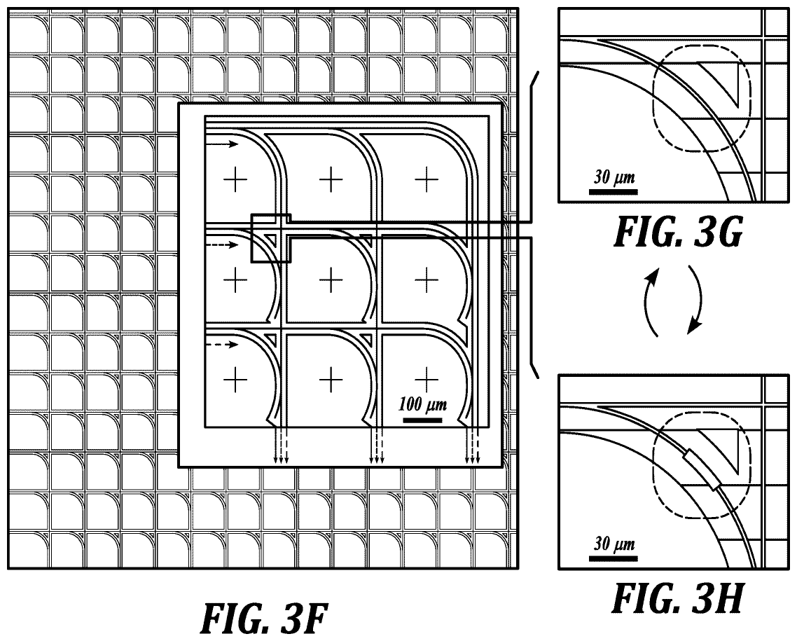

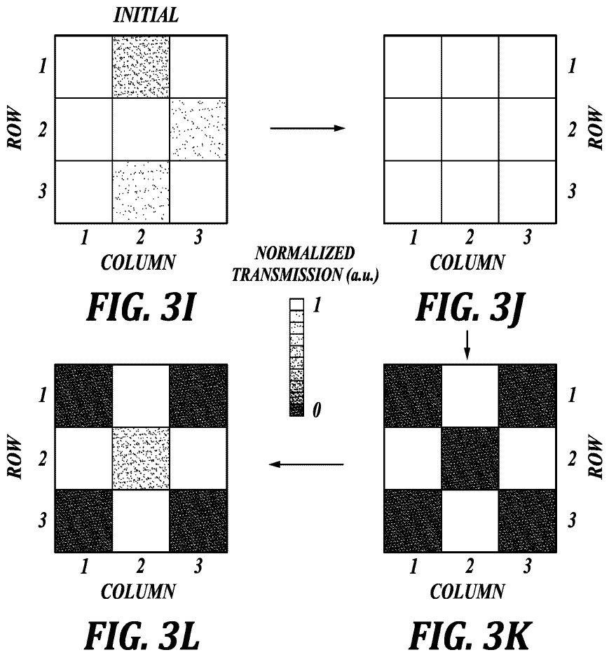

A programmable optical interconnect fabric is a useful photonic architecture to enable reconfigurable connectivity in telecommunication, computing, and network systems. In an embodiment, the DLW technique creates, routes, and reroutes such interconnect fabric on-demand. As shown, FIGS. 3A-3C depict a 3×3 array, which establishes connectivity between three input and output ports using cSb₂Se₃ waveguides. The connection configuration of the fabric is defined using a transmission matrix M in Sout=M Sin where Sout and Sin represent the output and input intensity vectors, respectively. As shown in FIG. 3A, the fabric was initially patterned to connect input/output ports in a configuration of 1 [symbol] 2, 2 [symbol] 1, and 3 [symbol] 3. The measurement result of this transmission matrix M shows that the extinction ratio between desired and undesired connections exceeds 20 dB (FIGS. 3D and 3E). The fabric was then rerouted by erasing all the waveguides in the designated connection region (FIG. 3B) and subsequently the waveguides were rewritten to establish new connections with an updated configuration. As illustrated in FIG. 3C, the switch array was rerouted to the configuration of 1 [symbol] 2, 2 [symbol] 3, and 3 [symbol] 1. The measured M changed accordingly but maintains a high extinction ratio >18 dB.

Additionally, in an embodiment, a residual image from the previous writing was visible even after completely erasing the pattern. The residual image does not impact the performance of the newly patterned devices, though. Without being bound by a particular theory, this residual imprint can be explained by the optical birefringence resulting from size and orientation variations in cSb₂Se₃ crystal grains during the annealing processes. Specifically, during the laser erasing process, the crystal grains grow in alignment with the moving direction of the laser spot, while no preferred growth direction is present during the thermal erasing process.

In an embodiment, a more complicated transmission matrix can be achieved by using a photonic crossbar array, which is a universal architecture for implementing multiply-accumulate (MAC) operation in linear optical computing. FIG. 3F displays the optical image of a 14×14 photonic crossbar array written on the PCM thin film. In an embodiment, a 3×3 sub-array is operated as a programmable MAC core. In an embodiment, the input vector is encoded by the intensities of optical signals in multiple wavelength channels, which are sent into each row of the crossbar array, respectively. As illustrated in FIGS. 3G and 3H, each unit cell of the crossbar array comprises a row waveguide, a column waveguide, and a cross-coupling waveguide, which extracts the input signal from the row waveguide and couples it to the column waveguide through optimized directional couplers. The output of each column waveguide is the weighted sum of the input signal at each row and is measured incoherently by a photodetector, thus performing the MAC operation for matrix-vector multiplication (MVM). In an embodiment, each matrix element is programmed in the transmission of each unit cell's cross-coupling waveguide (see FIG. 3F). The output vector is obtained by measuring the total output power in each column of the output channels. A more detailed elucidation of crossbar array implementation can be found in previous works.

In an embodiment, the 3×3 crossbar array was designed and direct-wrote to

$$\begin{matrix}1 & 1 & 1\end{matrix} \begin{matrix}1 & 1 & 1 \\ 1 & 1 & 1\end{matrix} .$$

equally distribute the input power into the output to represent the matrix. However, due to writing imperfections (similar to fabrication variation in conventional PICs), the matrix represented by the crossbar array exhibits errors, as shown in the measured results in FIG. 3I. Remarkably, the DLW technique makes it straightforward to adjust each element by locally modifying the cross-coupling waveguides, thereby correcting the error to restore the designed functionality (FIG. 3J). It is also easy to reprogram the matrix in a grayscale-like fashion by erasing or restoring a section of the cross-coupling waveguide. In an embodiment, the element at the center and four corners were set to 0 (FIG. 3K) and the center matrix element was decreased to 0.5 (FIG. 3L) to represent the matrix

$$\begin{matrix}0 & 1 & 0 \\ 1 & 0.5 & 1 \\ 0 & 1 & 0\end{matrix} .$$

### EXAMPLE 4: SHAPING SPECTRAL RESPONSE OF COHERENT PICS

Coherent PICs universally use interferometric and resonant components and require precise spectral responses for filtering and coherent signal processing. Because of inevitable fabrication imprecision, these components' spectral responses are shaped to meet these requirements. The DLW technique allows for incremental trimming of the spectral response of a coherent optical filter step-by-step, offering a highly controlled method for fine-tuning its performance. In addition, new coherent components can be added to change the spectral response entirely.

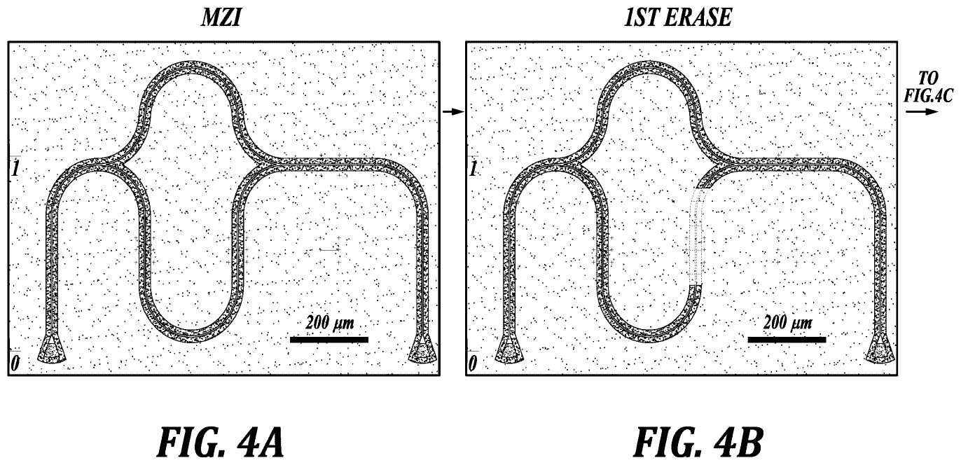

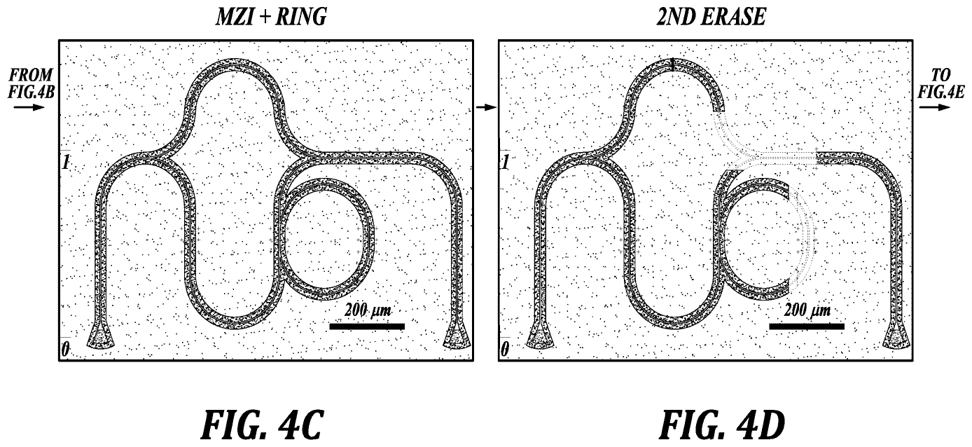

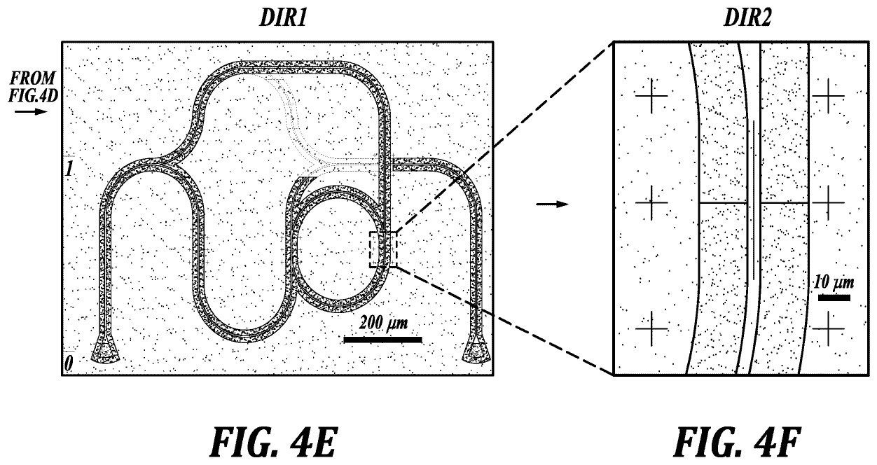

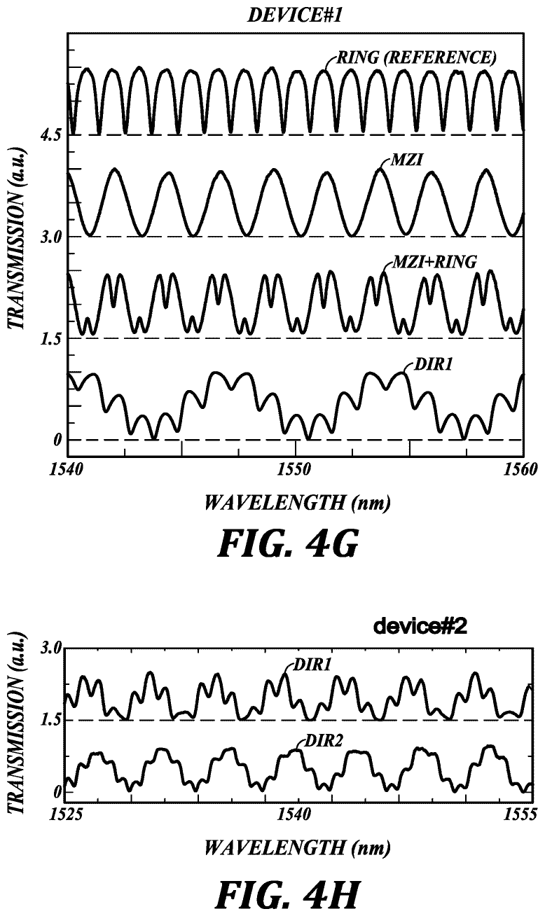

In an embodiment depicted by FIG. 4A, an MZI was written, which has a typical transmission spectral response as measured in the second panel of FIG. 4G. A section of the lower arm of the MZI was erased (FIG. 4B) and subsequently a racetrack ring resonator was added, as depicted in FIG. 4C. The resulting transmission spectrum of the ring coupled-MZI displays features the characteristics of both the MZI and the ring resonator, depicted in the third panel of FIG. 4G. Afterward, portions of both the ring resonator and the MZI were erased (see FIG. 4D) and the circuit was rewritten to include a double-injection ring (DIR) filter. In the DIR, the output light comprises cumulative contributions from two nominally identical add-drop ring resonators. The first contribution comes from the drop-port of the ring, with the input light incident from the lower arm of the original MZI. The second contribution originates from the through-port of the ring, with the light incident from the upper arm of the original MZI. As a result, the DIR exhibits a significantly different transmission spectrum with a much larger FSR (FIG. 4G, fourth panel). Finally, the DIR spectral response was trimmed by modifying its parameters. The coupling between the output waveguide and the racetrack ring resonators was adjusted. This was done by widening the gap between the waveguides from 350 nm to 500 nm and reducing the waveguide width (FIGS. 4E and 4F). The transmission spectrum of the modified DIR (DIR2 in FIGS. 4F and 4H) changes as expected, thus demonstrating the spectral tunability of the filter. All measured spectra from the filter agree well with the numerical models. This provides additional evidence of the stability and reliability of writing and rewriting the phase-change photonic circuits.

### EXAMPLE 5: ADDITIONAL VARIATIONS

The technique described in the present Example simplifies the complex nanofabrication processes typically required for fabricating integrated photonic devices down to one-step laser writing and enables reusing the same chip/die. Although the above examples utilized a commercial laser writer, it will be understood that the same results can be achieved with a much lower-cost laser writing system, which in an embodiment incorporates a laser diode, a focusing objective, a high-precision motion stage, and a computer control system. This approach leverages the versatility of the DLW and the nonvolatile, low-loss, and high-contrast properties of the phase-change material, offering an unprecedented level of flexibility. PICs consisting of a full package of elementary photonic components, including waveguides, grating couplers, ring resonators, MZIs, programmable optical switch fabrics, reconfigurable photonic crossbar array, and tunable optical filters, among others, are achievable with the devices, systems, and methods described herein. Although the previous demonstrations have been conducted in a near-in-situ fashion—in steps of writing, measuring, modifying, and checking—it is to be understood that, in an embodiment, real-time reconfiguration and feedback-controlled adaptation of the PICs are entirely feasible.

Moreover, in an embodiment, the application scenario includes a multi-level grayscale design instead of the current binary design. In an embodiment, the application scenario includes the selection of other substrates tailored to specific applications. For example, in an embodiment, the phase-change thin films are integrated on LiNbO₃-on-insulator substrates, enabling the development of programmable electro-optical or acoustic-optical circuits. These advantages underscore the potential of the DLW technique in enabling the rapid prototyping and testing of innovative photonic circuits, using only a low-cost tool that is affordable to a wide range of research and education communities.

### EXAMPLE 6: MODE AND WAVELENGTH DEMULTIPLEXER INVERSE DESIGN

Phase-change materials (PCMs) are promising in programmable photonic devices as their non-volatile and drastic change in optical properties (i.e., complex refractive index) between distinct phases. Meanwhile, inverse design in nanophotonics has emerged as a new approach to designing ultracompact and high-performance photonic devices with sub-wavelength structures to realize desired functional characteristics, such as mode and wavelength demultiplexers. In an embodiment, implementing inverse design by programming the phase-transition in the emerging low-loss phase-change material Sb₂Se₃, optically programmable inverse-designed demultiplexer are created, which can be reconfigured as either mode or wavelength demultiplexers. Combining the flexibility provided by low-loss phase-change material and the power of inverse design is promising for achieving on-chip field-programmable nanophotonic devices.

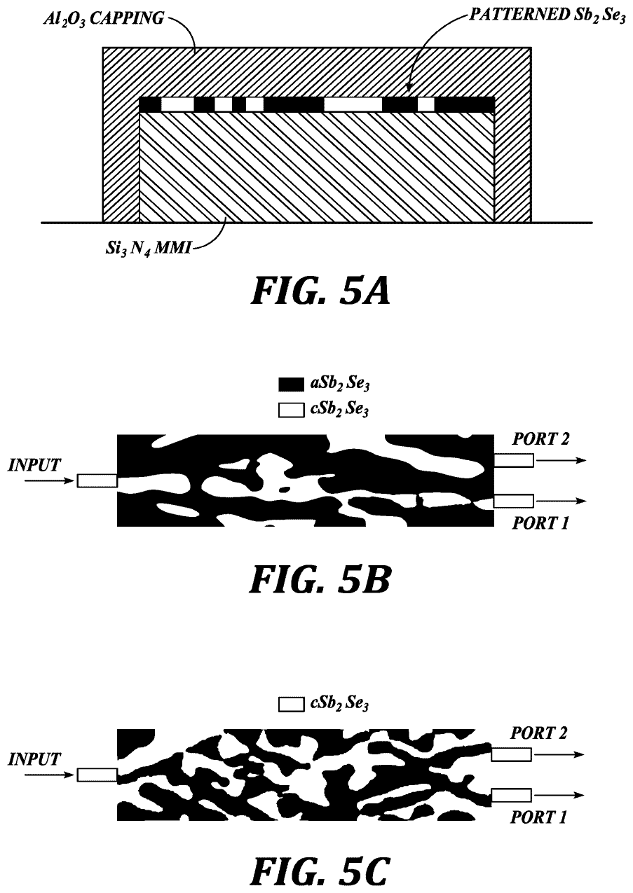

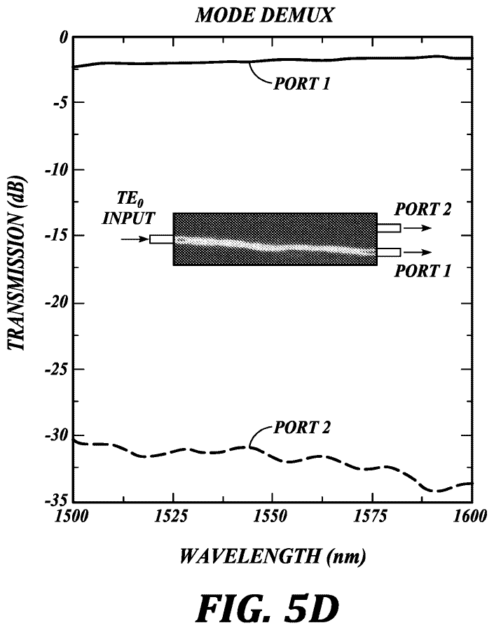

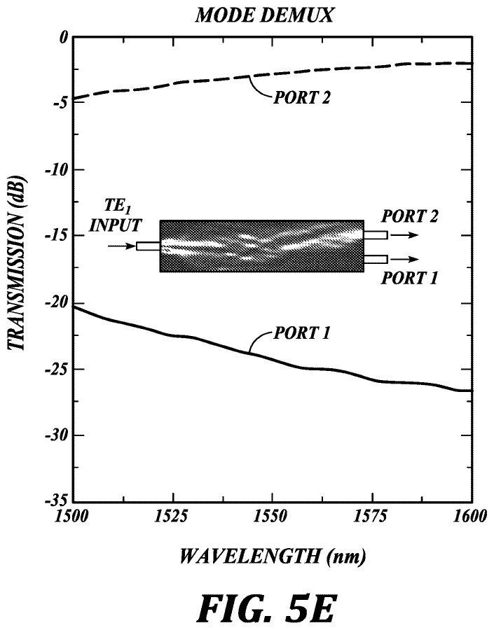

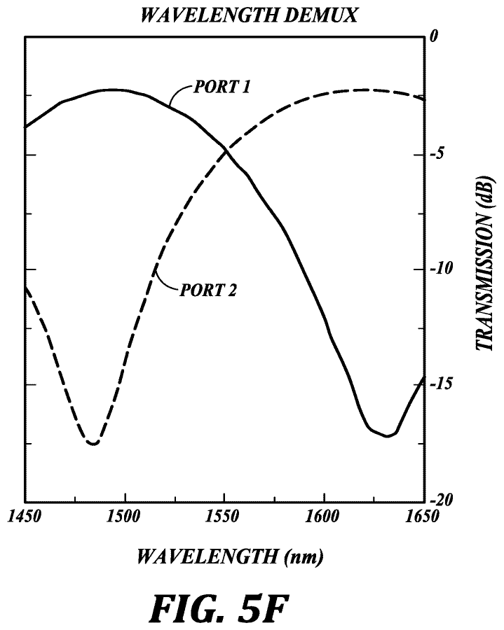

In an embodiment, optically programmable inverse-designed demultiplexers are based on Sb₂Se₃ film on a Si₃N₄-on-insulator substrate. In an embodiment, FIG. 5A shows two-channel mode and wavelength demultiplexer designs on a multi-mode interferometer (MMI) with a footprint of 30×8 μm². In an embodiment, the function of the demultiplexers is programmed by patterning the crystalline and amorphous phases of Sb₂Se₃ into inverse-designed subwavelength structures. The inverse design starts from linear parametrization, which allows the dielectric permittivity E to vary continuously and eventually delivers binarized results, generating the phase pattern of amorphous (aSb₂Se₃) and crystalline (cSb₂Se₃) Sb₂Se₃, as shown in FIGS. 5B and 5C. In an embodiment, in the mode demultiplexer design, the transmission of TE₁-TE₀ (input-output) and TE₁-TE₀ were respectively optimized for the output port 1 and port 2. Computational results for different input modes are shown in FIGS. 5D and SE, indicating that the subwavelength structures guide light at TE₀ and TE₁ modes to designated ports. In an embodiment, the binarized inverse design result for a wavelength demultiplexer is illustrated in FIG. 5F, where the 1510 nm light is coupled into the TE₀ mode of port 1, and the 1590 nm light is coupled into the TE₀ mode of port 2.

### EXAMPLE 7: MODE DEMULTIPLEXER

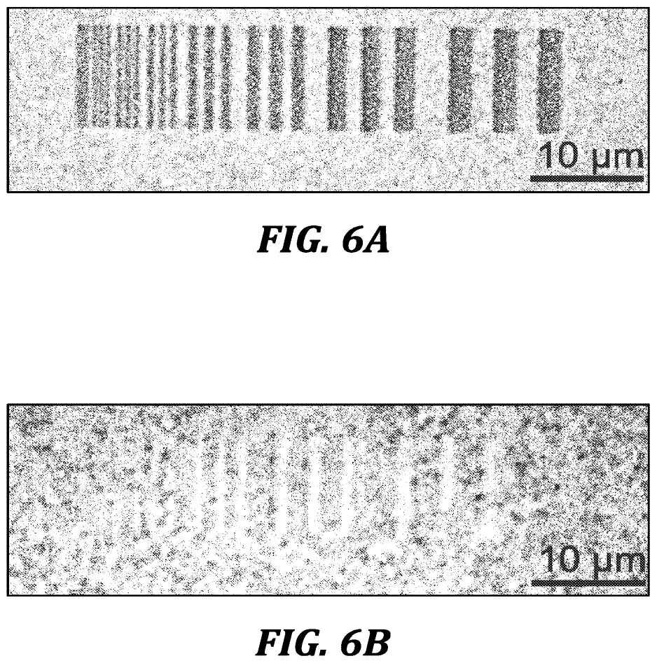

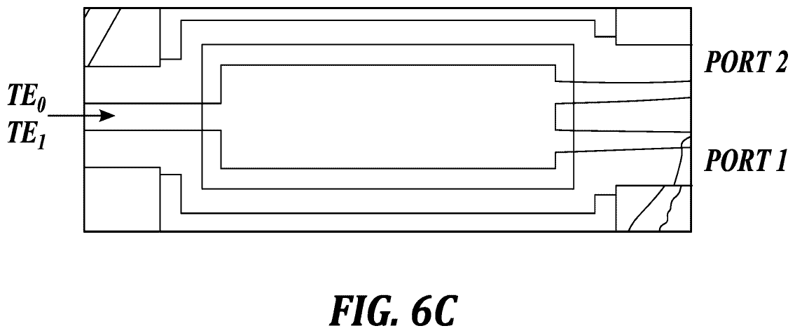

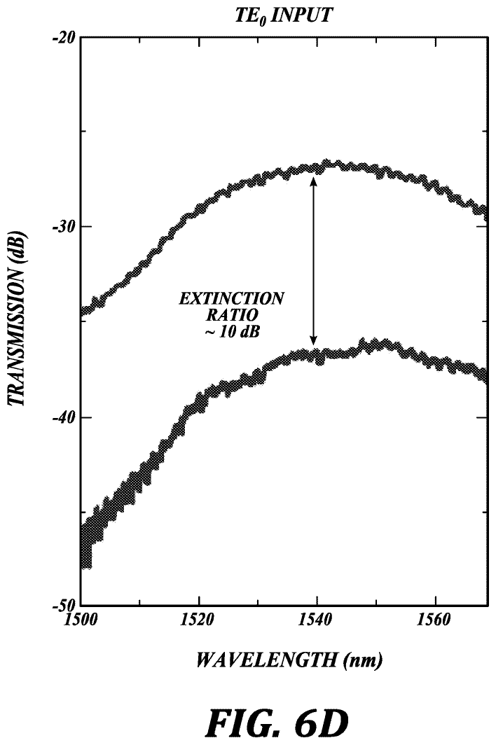

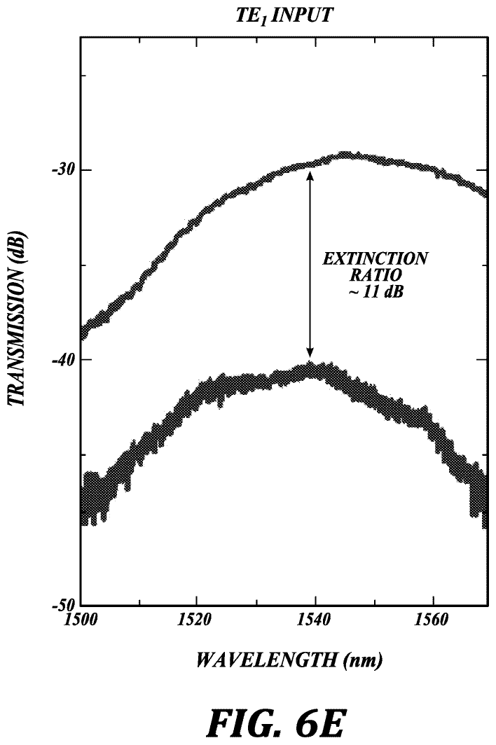

In an embodiment, a commercially available laser direct lithography system (Heidelberg DWL66+) was used to directly write the phase patterns by quenching cSb₂Se₃ into aSb₂Se₃. As shown, FIG. 6A shows the optical image of a series of aSe₂Se₃ rectangular written on a 30 nm-thick cSb₂Se₃-on-Si₃N₄ sample. The minimal feature size is around 300 nm. In an embodiment, the pattern can also be easily erased through a thermal annealing process at 180 C (see FIG. 6B). As a demonstration, the 30×8 μm2. MMI is programmed as a mode demultiplexer. In an embodiment, the Sb₂Se₃ phase pattern is carefully aligned to make it match the simulated design with a negligible error (see FIG. 6C). FIGS. 6D and 6E present the measured transmission spectrum when the TE₀ mode and the TE₁ mode incident into the device. The TE₀ and TE₁ light input into the device output at port 1 and port 2, respectively, with a high extinction ratio for both input modes over 10 dB. The experimental result is in agreement with the simulation.

In an embodiment, the function of the device can be programmed by optically writing and erasing Sb₂Se₃ phase patterns. The mode demultiplexer shows high extinction ratios for TE₀ mode and TE₁ mode input. The high flexibility provided by low-loss phase-change material and inverse design is promising for achieving an on-chip trainable photonic device.

### EXAMPLE 8

Integrated photonic network-on-chip (NoC) fabrics can provide multiple terabits per second (Tbps) bandwidth for high-performance computing servers supporting the latest artificial intelligence. To maximize the utility of the photonic hardware, these optical networks can multiplex data streams in multi-dimensional channels encoded in optical wavelengths, modes, and polarization states. A generic photonic platform that can be reconfigured to implement functionalities in those dimensions is highly desirable to streamline the design and manufacturing of integrated photonic networks. Here, the present disclosure demonstrates a multi-functional photonic device using phase-change material Sb₂Se₃ that can be reconfigured from a wavelength-division demultiplexer to a mode-division demultiplexer. The reconfiguration is achieved by direct laser writing of phase patterns optimized with the inverse design technique. The demonstrated programmable phase-change photonic devices hold immense promise for a wide range of photonic applications requiring adaptable functionalities, including on-chip and in-package optical interconnects, optical signal processing, photonic tensor cores, and future optical computing for artificial intelligence.

Recent advancements in large-scale photonic integrated circuits have unveiled the potential of in-package and on-chip optical networks that affords a remarkable leap in bandwidth density compared to traditional electrical interconnects and networks. This advancement paves the way for unprecedented bandwidth and energy efficiency for communications among crucial system components like processors, memory modules, and storage units, potentially transforming the architecture of high-performance computing systems and data centers for the advent of artificial intelligence (AI), especially the generative type. In today's integrated photonic systems, programmability and reconfigurability stand as highly desired features, essential for empowering diverse technologies—from next-generation data centers to optical neural networks and quantum information processing. Within this context, the development of an on-chip, high-density photonic network fabric allowing dynamic reconfiguration emerges as a pivotal element. An exemplary instance is the Google TPU v4, employing MEMS-based optical circuit switches to configure the interconnect topology, thereby enhancing scalability and power efficiency in machine learning models. Such a network-on-chip fabric plays a vital role in effectively managing data flow across various functional units within the system. A building block in creating this fabric is a multi-functional photonic device enabling post-fabrication programming, an immensely desired capability for agile reconfigurable photonic functionalities. However, conventional programmable photonics devices such as phase shifters, directional couplers, and beam splitters based on Mach-Zehnder interferometers (MZIs) have limitations: while programmable in operational parameters, their functionality is hardcoded and cannot be changed. Therefore, new devices with modifiable functionality will provide even greater flexibility in adjusting the configuration and topology of the photonic network to optimize it for various algorithms and thus are highly desirable.

Chalcogenide phase-change materials (PCMs) present a promising solution to realize programmable photonics due to their nonvolatile, reversible microstructural phase transition, the ability for multilevel operation, and significant refractive index contrast between phases. PCMs, including Ge₂Sb₂Te₅, GSST, Sb₂Se₃, or Sb₂S₃, have been incorporated in Mach-Zehnder interferometers (MZIs) and directional couplers for phase modulation and in ring resonators for resonance tuning. In these applications, the PCMs are only used to tune the photonic devices' parameters rather than changing their functionalities, which should be possible considering the very high optical index contrast afforded by PCMs. Moreover, a variety of sophisticated design optimization techniques can be implemented in PCM-integrated photonic devices to enable programmability. These methods include genetic algorithms, semi-analytical approaches, and notably, inverse design. Inverse design, in particular, has expanded the exploration of design spaces, yielding devices with exceptionally compact footprints and superior performance metrics.

The Example provides a reprogrammable, multi-functional photonic device achieved by integrating the low-loss phase-change material, Sb₂Se₃, on a multi-mode interferometer (MMI). Employing the direct laser writing technique in conjunction with inverse design optimization, the device's functionality is modified by transferring the inverse-designed phase pattern to the Sb₂Se₃ thin film while preserving the integrity of other components. Remarkably, the functionality of this phase-change MMI device is rewritable, allowing for the erasure and recreation of the Sb₂Se₃ phase pattern. This capability completely transforms the device's functionality, making it adaptable to different application scenarios. As a demonstration, this device is programmed to function as a wavelength-division multiplexing (WDM) device and subsequently changed it into a mode-division multiplexing (MDM) device. This result showcases the ability of phase-change photonic devices to enable flexible integrated photonic circuits for multi-dimensional communication schemes, switchable or combining wavelength- and mode-multiplexing functionalities.

### Results

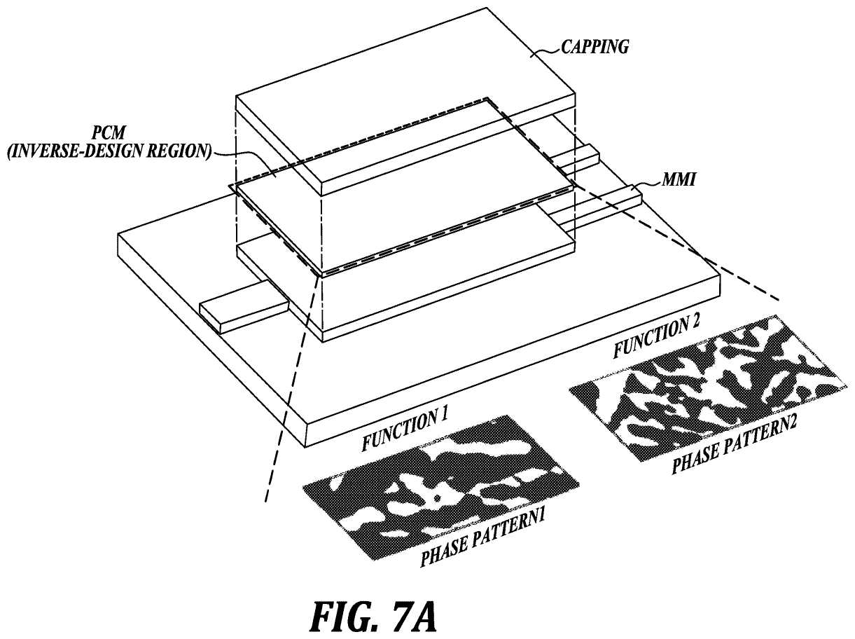

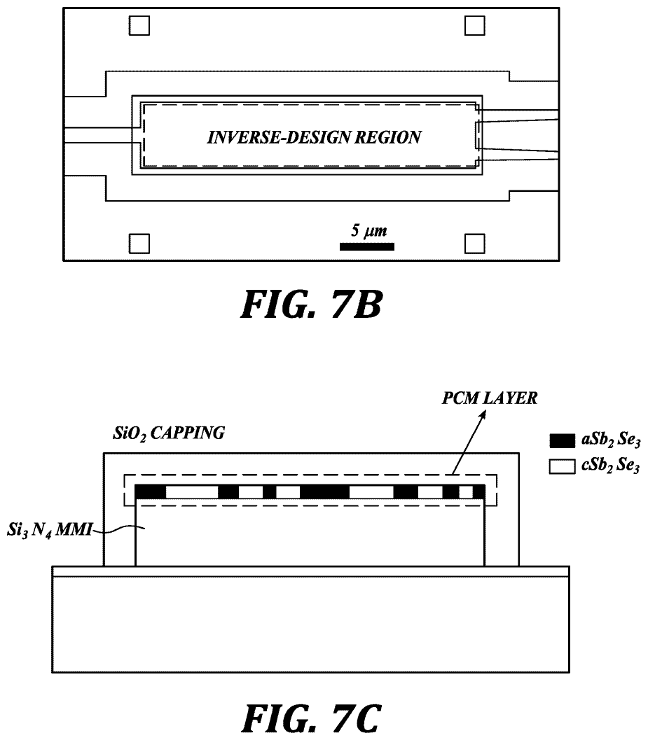

FIG. 7A illustrates the schematic of the proposed reconfigurable multi-functional 1×2 MMI. Each MMI, occupying a footprint of 40×8.5 μm², is fabricated on a 330 nm-thick Si₃N₄-on-insulator substrate. A 30 nm-thick low-loss phase-change material, Sb₂Se₃, is sputtered onto the MMI and protected by a 200 nm-thick SiO₂ capping layer. The significant refractive index contrast between the two phases of Sb₂Se₃ (amorphous: nₐ=3.285 and crystalline: n_{c}=4.050, respectively) allows efficient evanescent coupling of light within the MMI with the Sb₂Se₃ thin film. As a result, the light undergoes a phase modulation that depends on the local structure of Sb₂Se₃. By inducing localized perturbations, the phase pattern of Sb₂Se₃ on MMI shapes the wavefront during light propagation, altering the amplitude and phase distribution of the propagating light. This capability allows the MMI to execute diverse functions with minimum loss penalty. In particular, the specific function of the MMI device can be associated with a distinct binary Sb₂Se₃ phase pattern within the “inverse-design region” highlighted by the dashed box in FIG. 7B. Furthermore, as depicted in FIG. 7C, the MMI's function is entirely encoded within the PCM thin film, while the other components remain unchanged. The reversible phase change of Sb₂Se₃ allows for convenient erasure and recreation of the phase pattern, enabling a complete transformation of the device's functionality to cater to vastly different application scenarios.

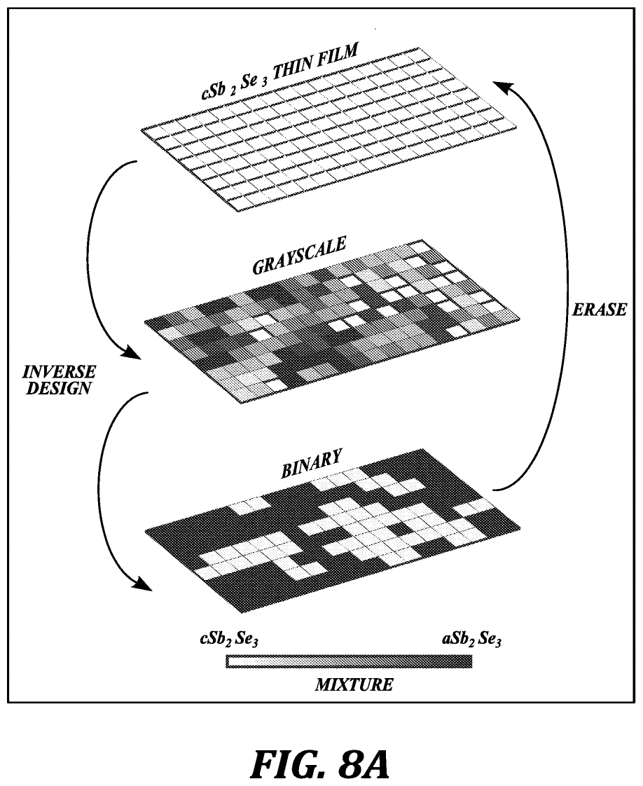

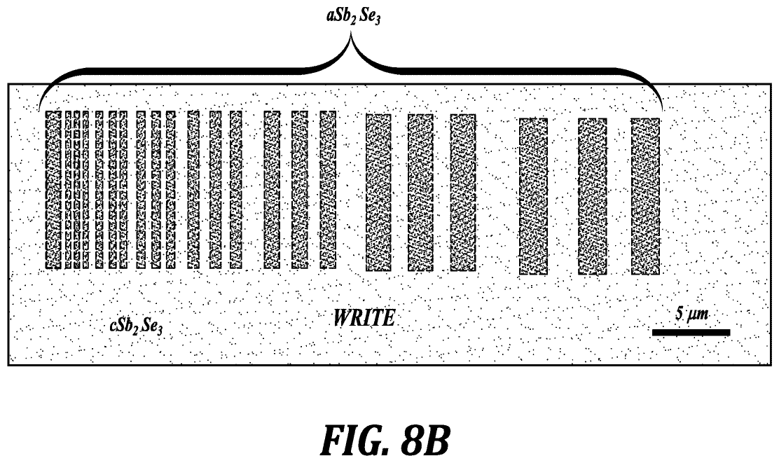

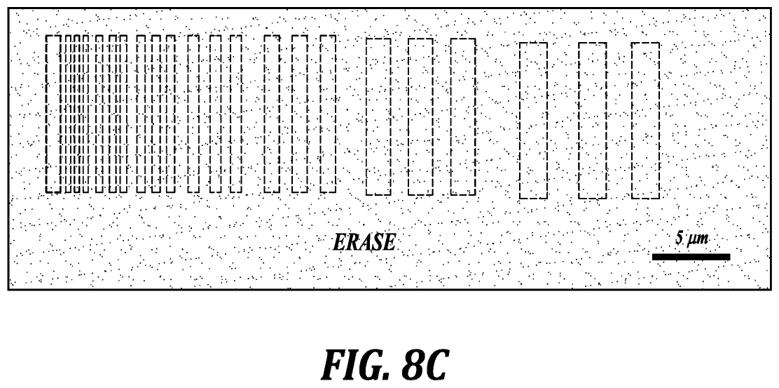

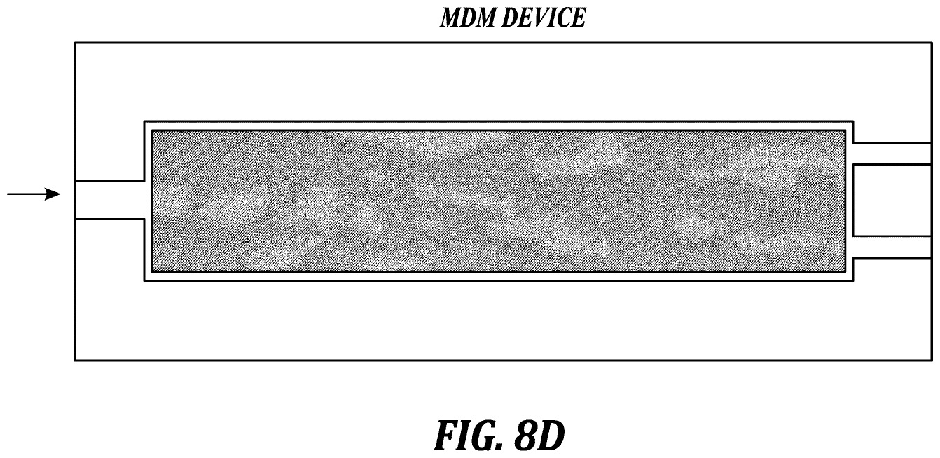

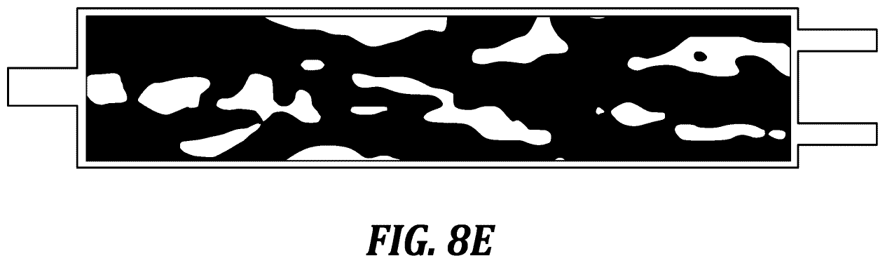

Programming the MMIs involves designing and patterning processes. First, the MMI's function is determined and the corresponding Sb₂Se₃ phase pattern is designed. To achieve this, a topology optimization approach is applied to inverse-design the phase pattern of the Sb₂Se₃ thin film. In simulations, the Sb₂Se₃ thin film within the “inverse-design region” is segmented into an array of pixels, each measuring 100 nm×100 nm×30 nm, while maintaining the other components of the MMI unchanged during optimization. To avoid unachievably fine features, the minimum feature size in the designed patterns is limited to be larger than 500 nm. The optimization process initiates with a linear parametrization, allowing the dielectric permittivity E, of each pixel to continuously vary in the range of (nₐ, n_{c}). Subsequently, the phase pattern is updated using the steepest descent method. Through this gradual optimization process, the permittivity of the pixels transitioned from an intermediate value in (nₐ, n_{c}) toward a binary value of nₐ or n_{c}. Consequently, the phase map evolved from a grayscale phase pattern to the binary phase pattern of Sb₂Se₃, as illustrated in FIG. 8A.

Second, the corresponding phase pattern is directly laser written onto the MMIs using a commercial 405 nm laser direct lithography system (Heidelberg DWL 66+, 405 nm laser). The exceptional speed and accuracy of the DWL system enable efficient and effective patterning of the target MMI device. During the experiment, the Sb₂Se₃ thin film began in the completely cSb₂Se₃ phase and wrote phase patterns directly onto the MMI by quenching cSb₂Se₃ into aSb₂Se₃ phase using optical heating. FIG. 8B displays a series of rectangular aSb₂Se₃ patterns with widths ranging from 200 nm to 2 μm written on a blank cSb₂Se₃ film, demonstrating a minimum feature size of −300 nm achieved through laser writing. It is noted that this resolution reaches the subwavelength regime and is much smaller than the resolution achieved in previous works. Furthermore, the pattern can be readily erased through an annealing process, either by local heating using a continuous-wave laser or global heating to 180 °C using a hotplate (see FIG. 8C). By selectively erasing and rewriting the patterns on MMIs, the function of the circuit is reprogrammed. This technique gives a toolkit for writing high-finesse functional patterns into the phase-change films and modifying or erasing them as required.

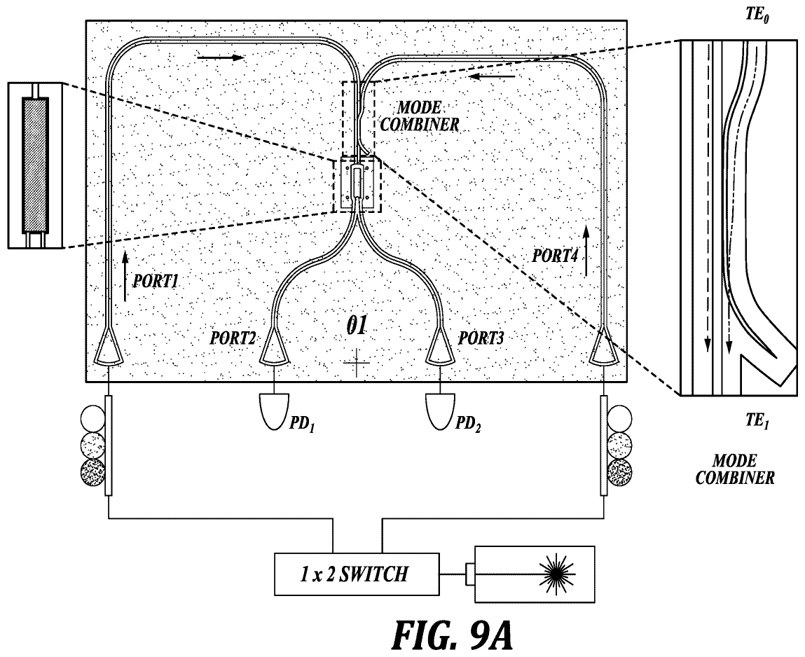

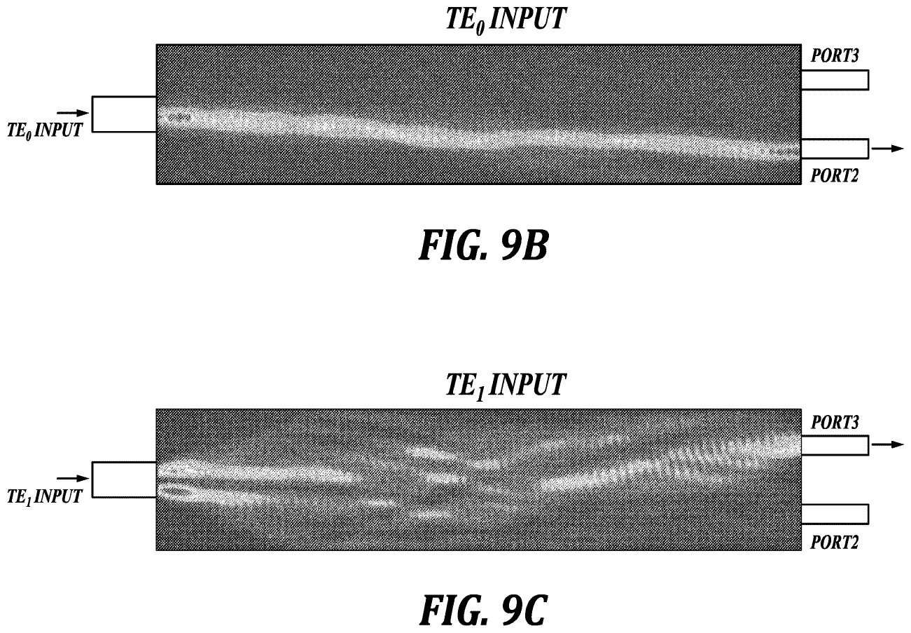

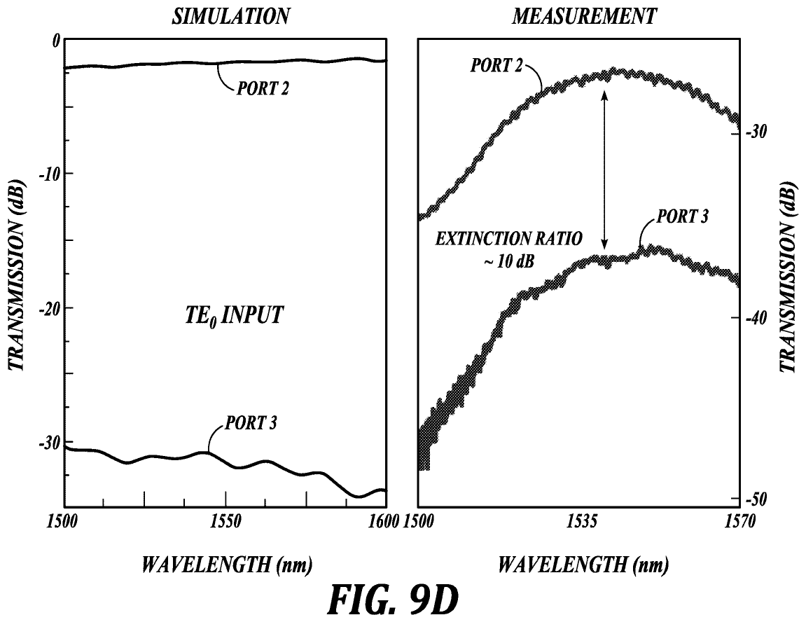

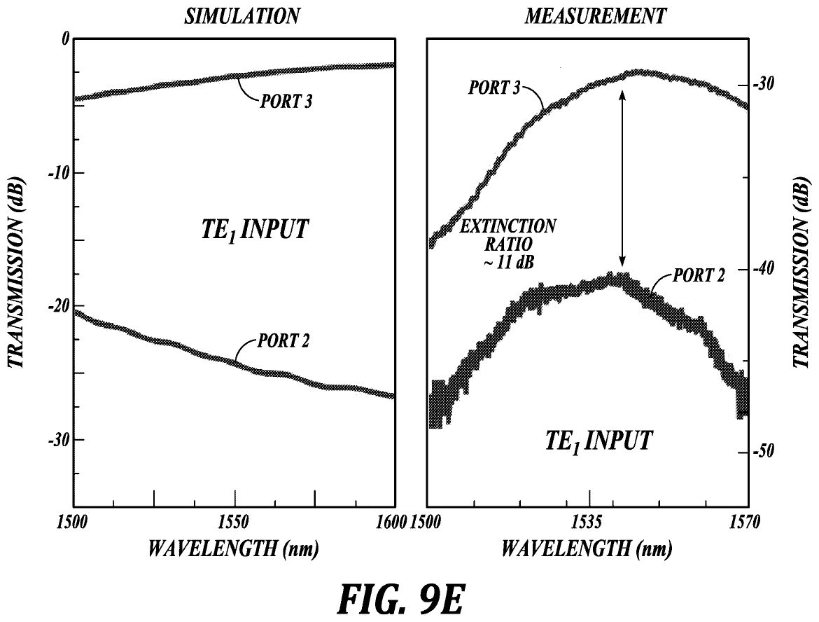

Using the direct writing technique, the present Example first demonstrates programming the MMI as a mode demultiplexer (MDM). The Sb₂Se₃ phase pattern (FIG. 8E), generated with the inverse design approach, was precisely aligned (misalignment <125 nm) and written onto the MMI. As shown in FIG. 8D, the laser-written phase pattern closely resembles the design with minimal error. Subsequently, the MDM performance of the MMI device was characterized. FIG. 9A shows an optical microscope image of the complete photonic circuit and a sketch of the measurement setup. A multimode waveguide, supporting both TE₀ and TE₁ modes, is connected to the input of the MMI, while both output ports (port 2 and port 3) are linked to single-mode waveguides for measurement. The incident light is coupled to the device via either port 1 or port 4 and passes through a mode combiner constructed with an asymmetric directional coupler. This combiner selectively converts the incoming TE₀ mode from incident port 4 to the TE₁ mode while maintaining the TE₀ mode from input port 1. As a result, the input mode to the MMI is determined based on which port is used (port 1 for TE₀ or port 4 for TE₁), which is selected using a 1×2 optical switch. Finally, the output power from both output ports (port 2 and port 3) was measured to determine the respective transmission coefficients of each mode.

FIGS. 9B and 9C illustrate the MDM's functionality, routing the TE₀ mode to port 2 and the TE₁ mode to port 3 over a wavelength range of 1500 to 1600 nm. FIGS. 9D and 9E compare the simulated and measured transmission spectra of the two modes. In the simulation, this MDM device demonstrates a modal extinction ratio surpassing 15 dB for both mode channels over a bandwidth wider than 100 nm. The experimental results exhibit an extinction ratio of >10 dB for both mode channels, lower than the simulated values. The underperformance may be attributed to fabrication imperfections, misalignment, and roughness in the phase pattern. Additionally, according to measurements, the grating couplers constrain the insertion loss and operational bandwidth. Furthermore, three identical devices were fabricated, which demonstrated similar performance, manifesting the consistency of the design and fabrication approach.

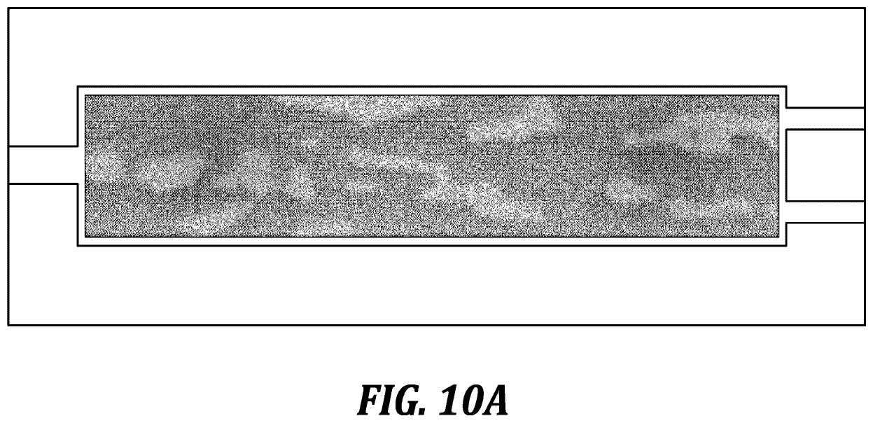

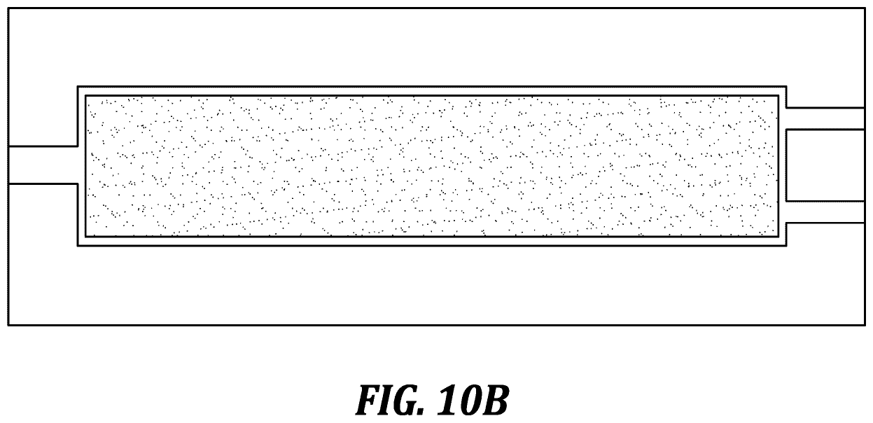

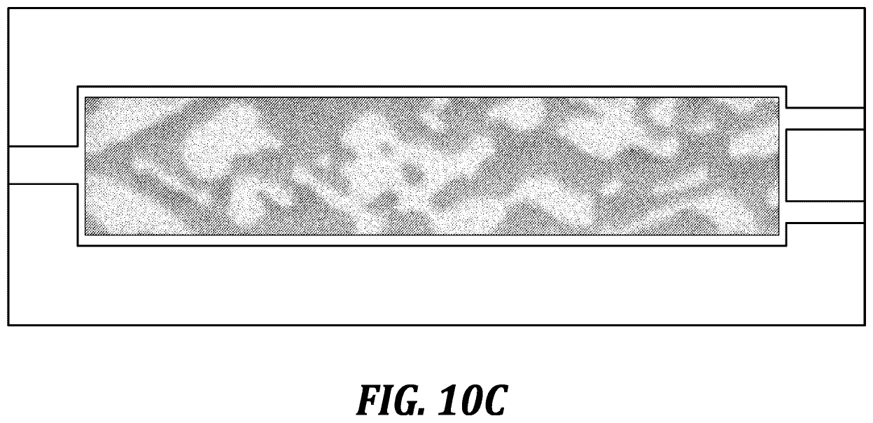

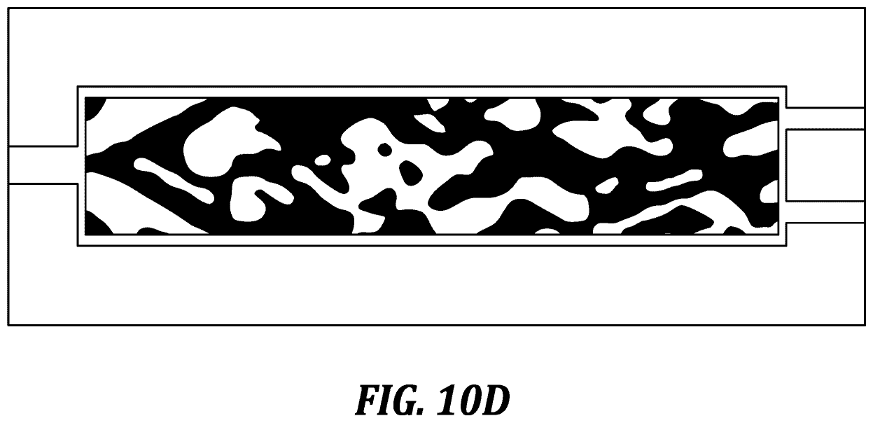

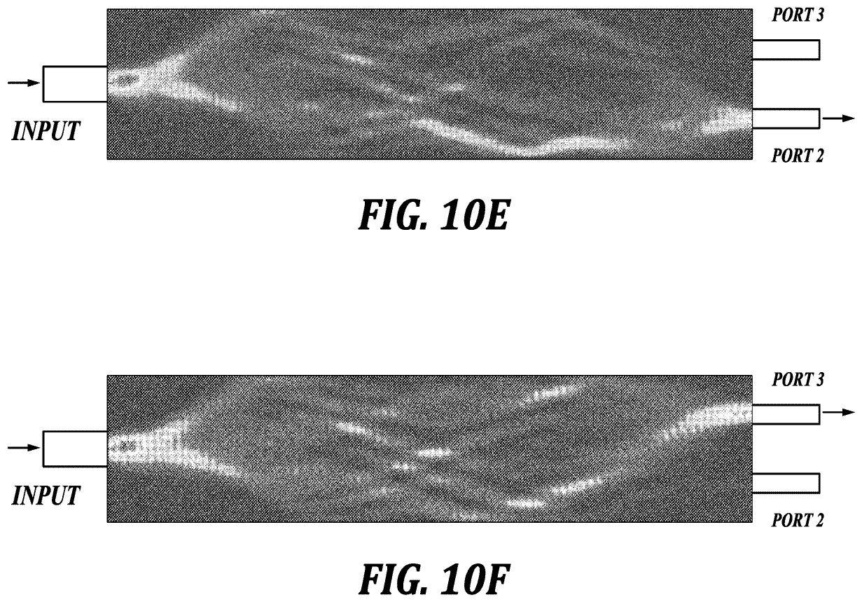

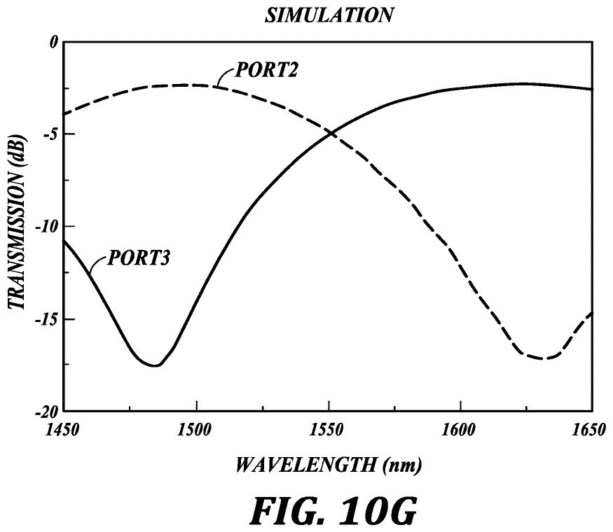

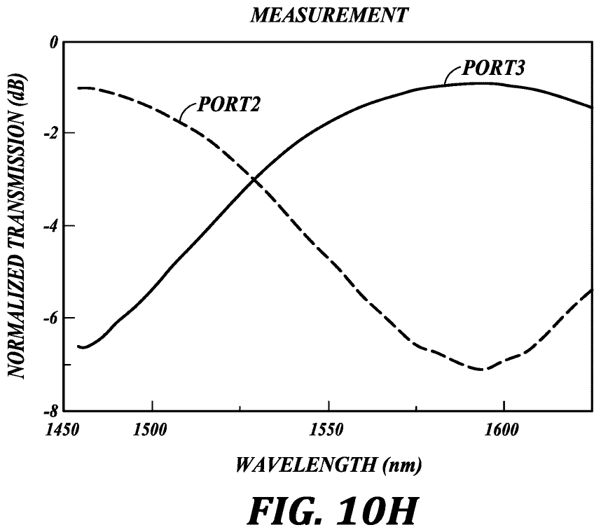

Reprogramming the functionality of the MMI from an MDM to a wavelength demultiplexer (WDM) was demonstrated. To do so, the previous Sb₂Se₃ phase pattern was erased and rewrote a newly designed phase pattern onto the same MMI, as shown in FIGS. 10A-10C. To accomplish the WDM function, the phase pattern was redesigned within the “inverse-design region” using the same method described earlier (FIG. 10D). FIGS. 10E and 10F show the simulated electric field distribution at two operating wavelengths of 1475 nm and 1625 nm, respectively. The WDM separates the TE₀ mode of the input waveguide into the two output ports according to their wavelength: 1475 nm at port 2 and 1625 nm at port 3. FIGS. 10G and 10H plot the measured and simulated transmission spectra for the WDM, respectively. The simulation shows a high extinction ratio of >15 dB at the center wavelengths. The experimental results show a lower extinction ratio of >6 dB measured at wavelengths of 1465 nm and 1695 nm, which is limited by the range of the tunable laser source used. The reduced performance can again be attributed to fabrication imperfections and pattern misalignment. Nevertheless, the results successfully demonstrate a complete change of the device's functionality, from an MDM to a WDM, by recreating the phase pattern of the Sb₂Se₃ thin film.

### CONCLUSION

In summary, the present Example demonstrates the versatility of a multi-functional photonic device achieved through the integration of low-loss phase-change material Sb₂Se₃ onto a silicon nitride photonic integrated circuit, where functionality is encoded in the phase pattern of the Sb₂Se₃ thin film. Leveraging direct laser writing and inverse design optimization, this novel phase-change MMI device offers excellent flexibility for a single photonic device. The present Example shows successful programming of this device to operate as multiplexers for either wavelengths or spatial modes. Utilizing photonic inverse design ensured high extinction ratios and broadband response in both configurations. Moreover, the present technology can be applied to scenarios by adopting a multi-level grayscale design instead of the current binary design and cascading multiple stages of such photonic structures to enable a diverse range of complex reconfigurable photonic systems.

### EXAMPLE 9: DIRECT WRITE 3D PHOTONIC INTEGRATED CIRCUITS (PIC) IN PHASE-CHANGE MULTI-LAYERS

The present Example describes using multiple layers of PCM to create 3D PICs in multilayers. The layers of PICs can be coupled vertically so that optical signals can be routed from layer to layer. The coupling can be through evanescent coupling between waveguides in two adjacent layers or radiation coupling between grating couplers in different, non-adjacent layers.

The method to create multilayer PICs in PCM layers is illustrated in FIG. 11A. Multilayers of PCMs can be deposited on a common substrate, such as silicon dioxide on silicon wafers or glass substrate. Sb₂Se₃ can be used as a PCM because of its low optical loss in both crystalline and amorphous phases for the telecom spectral range. The films can be deposited using sputtering or evaporation methods. Each layer of PCM can have a thickness in the 10 nm to 500 nm range. A spacer layer, typically made of silicon dioxide, is deposited in between each PCM layer. Other optical materials with relatively low refractive indices, such as titanium oxide and silicon nitride, can also be used as the spacer layer. The spacer layer can have a thickness of 50 nm to 1000 nm. Therefore, a multilayer stack of PCM/spacer with up to ten or more repetitions can be deposited.

To write the PICs using a laser writer, the laser is focused by an objective lens on one of the PCM layers in the multilayer stack. The location of the focal plane of the lens determines in which PCM layer the PICs will be created. Therefore, by adjusting the focal point of the objective lens or moving the multilayer substrate up and down, the PICs can be selectively written in each PCM layer. The layers that are out of the focus of the laser/objective will not be affected because the optical intensity is much lower than the threshold for inducing phase transition. If the substrate is not transparent to the laser, the laser will be focused from the top of the multilayer stack. If the substrate is transparent to the laser, such as glass, the laser can be focused from either the top or the bottom of the multilayer stack. A wide range of laser wavelengths can be used to write since the writing mechanism is based on optical heading-induced phase transition in the PCM.

Initially, all the PCM layers will be turned into the crystalline phase by a thermal anneal process. During the laser writing, the laser selectively turns the PCM at the focal point to the amorphous phase, which has a lower index and forms the lateral cladding. The writing follows a pre-designed pattern of the PICs. The crystalline phase PCM is used as the core of the waveguide and other components of the PICs, as shown in FIG. 11B. The approach of writing PICs in each PCM layer is the same as in a single PCM layer, as described earlier. Each layer is written sequentially. Using a lower laser power and slower writing speed, the same laser can also erase previously writing patterns by turning amorphous phase PCM back to crystalline phase PCM.

FIG. 11B illustrates how the PICs in the multilayers can be coupled through evanescently coupled. If two PCM waveguides are aligned in parallel, their optical modes will couple, forming hybrid modes of symmetric and asymmetric mode. The coupling rate is determined by the vertical distance of the two waveguides, which can be modeled theoretically using the coupled mode theory or numerically simulated. The in-plane distance of two waveguides in parallel determines the coupling ratio between the two waveguides, allowing optical signals coupled completely from one waveguide to another waveguide, vice versa or at any ratio. For example, 50% of the optical signal power can be coupled from one waveguide to another waveguide when the two waveguides can be designed to be 50/50 couplers. Coupling through multilayers can be achieved by sequential coupling between adjacent layers. For example, from the first layer to the second layer, then from the second layer to the third layer, so the optical signal is routed from the first layer to the third layer.

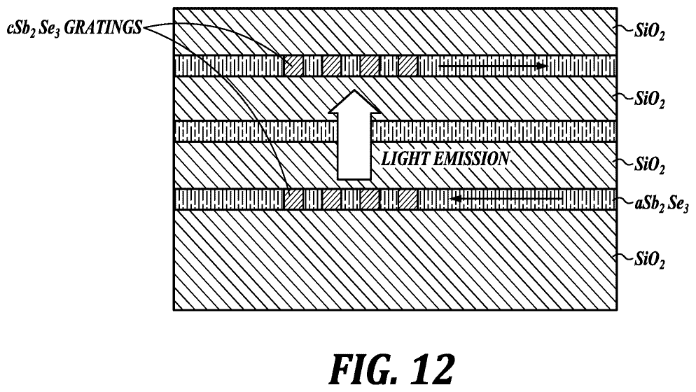

If the two waveguides are laterally separated from each other by a large distance, they will not couple despite their vertical separation being small. This allows freedom to control the routing and coupling among the layers in 3D. Direct interlayer coupling between non-adjacent layers can also be achieved with grating couplers, as illustrated in FIG. 12.

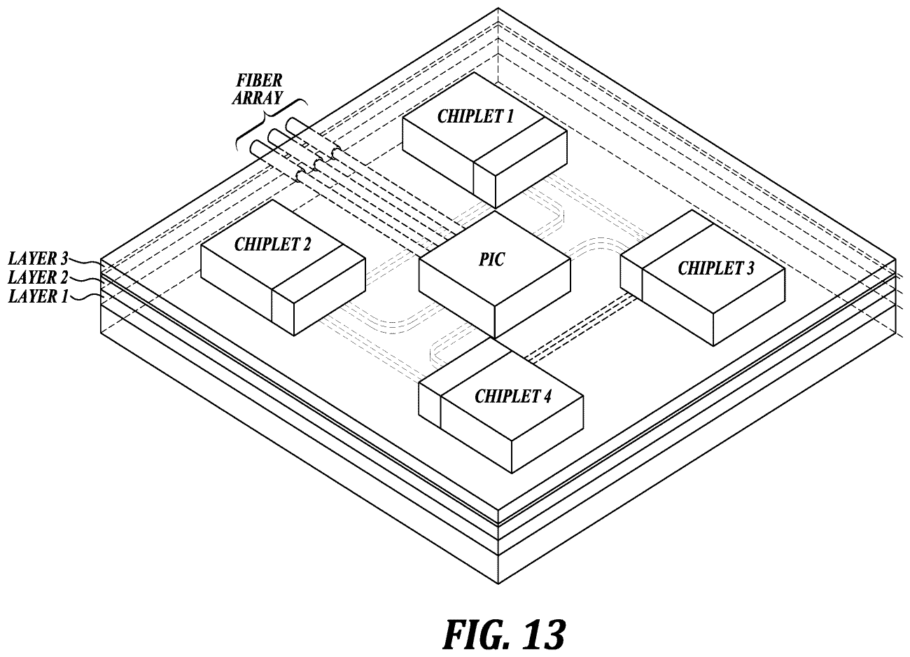

Such a 3D photonic interconnect capability will enable many possible applications. One example is an integrated photonics interposer in a system-on-chip (SoC) architecture, as illustrated in FIG. 13. Chiplets of CPUs, GPUs, high-bandwidth memories (HBMs), silicon-based photonic integrated circuit (PIC) chips can be mounted on a common substrate. PCM multilayers are deposited on the substrate. Multilayer PICs can be patterned using the laser writing approach in the PCM multilayer to provide photonic interconnect between the chiplets. The PCM PICs can be pre-patterned before the mounting of the chiplets, or created after the chiplets are mounted. The latter approach reduces the difficulty of alignment when mounting the chiplets and increases the yield. Because the PCM based PICs can be erased and re-written, they can be readily modified for correcting misalignment, or for reconfiguring the system to optimize in different application scenarios. The whole interposer, thus, is repairable and serviceable. The 3D, multilayer PIC structure also allows high connection density and significant flexibility in the topology of connection networks.

### Direct Write Multilayer Meta-Surface/Meta-Optics in Phase-Change Multi-Layers

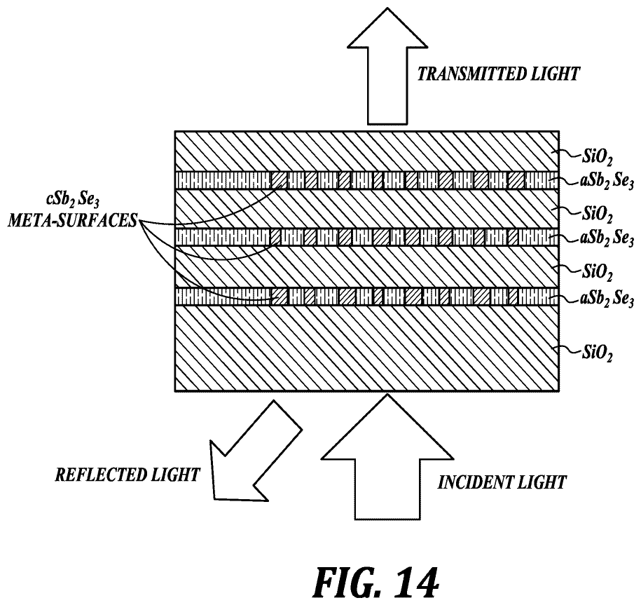

The PCM multilayers can also be used to create multilayer meta-surfaces or volumetric meta-optics, as illustrated in FIG. 14. By direct laser writing, meta-surfaces can be created in each PCM layer in the forms of nanostructures or microstructures (also called meta-atoms) of crystalline and amorphous phases of the PCM. The high index contrast between the two phases affords efficient phase modulation of the light that is scattered, transmitted, or reflected by the nanostructures. Through the rational design of the meta-atoms and their arrangement, meta-surfaces with designed functions can be created. The laser direct write method further allows the creation of meta-surfaces in multiple layers of PCM.

Multilayers of meta-surface can function collectively or sequentially to control the wavefront of incident light by shaping the amplitude and phase. This meta-surface or meta-optic system can function in either transmission or reflection modes, as illustrated.

FIGS. 15A and 15B illustrate a method to pattern multilayer PCM meta-optics using a laser writer. Alternating layers of PCM and cladding material, such as SiO₂, can be deposited on a transparent substrate. The laser beam is focused on each PCM layer, changing its phase from amorphous to crystalline, or vice versa, through optical heating. The laser is then scanned and modulated to create arbitrary patterns as designed for achieving the meta-optics functions. The depth of focus of optics used to focus the laser determines the writing precision in the depth of multilayers. If two adjacent PCM layers are coupled, the meta-optics pattern forms non-local meta-atoms. Otherwise, for example, two PCM layers with an additional spacer layer so they are more separated vertically, they are not optically coupled so forming local meta-atoms. If the meta-surfaces in each layer are not coupled with each other and function independently, such a system is called local. If the meta-surfaces in the layers couples optically, they are non-local. Such a non-local multilayer meta-surface can also be called volumetric meta-optics. These systems can be used to realize an achromatic lens that is ultrathin. They can also be used for holographic display, spatial mode control, optical signal processing and computing, and more.

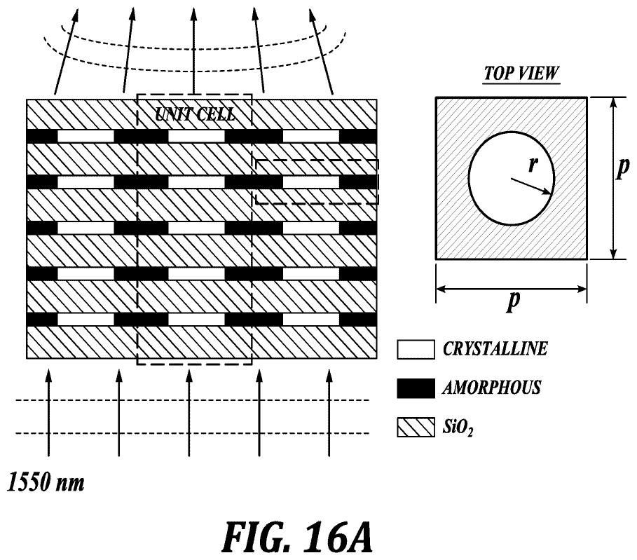

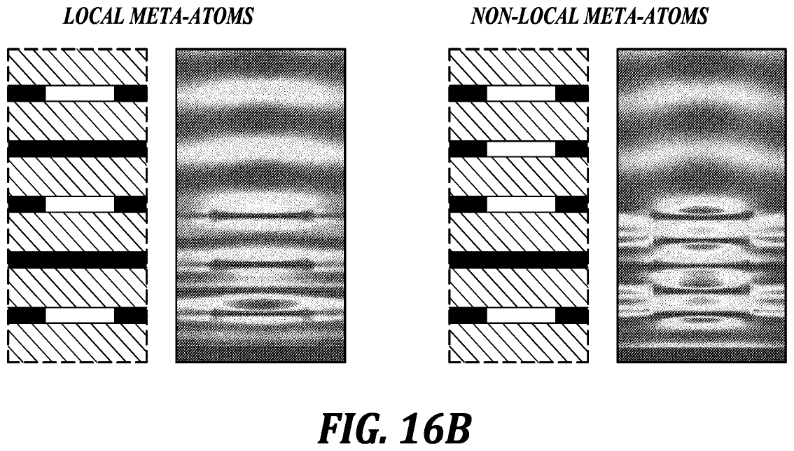

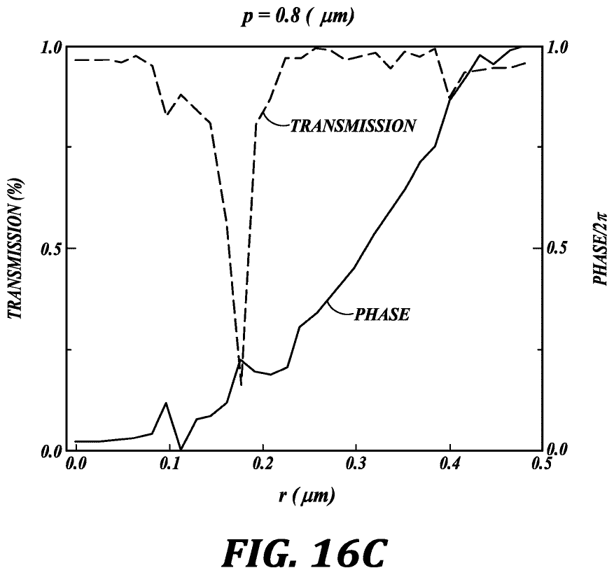

FIGS. 16A-16C show an example of meta-optics design (16A), in which each meta-atom (16B) is a circular disk. The design parameters include the radius (r) of each disk and the spacing (p) between each disk. Our simulation shows that the phase shift of transmitted light at 1550 nm wavelength can be varied from 0 to 2*pi when the radius r is changed from 0 to 0.5 μm (16C). Changing the spacing parameter p can have similar effects. The parameters r and p can vary spatially in the plane of the layer and through multiple layers to realize the designed optical functionality such as achromatic lens, holographic display and more.

### EMBODIMENTS

Embodiments of the present disclosure will now be listed.

1. A photonic integrated circuit (PIC) device comprising:
a substrate;
a phase-change material layer comprising a phase-change material disposed on the substrate, wherein the phase-change material comprises an amorphous phase subregion and a crystalline phase subregion; and
an oxide layer coating the phase-change material layer.

2. The PIC device of embodiment 1, wherein the phase-change material is configured to change phases between a crystalline phase and an amorphous phase upon illumination with light.

3. The PIC device of embodiment 1, wherein the phase-change material layer comprises a low-loss phase-change material layer.

4. The PIC device of embodiment 1, wherein the phase-change material layer comprises a material selected from the group consisting of Ge₂Sb₂Te₅, Sb₂S₃, Sb₂TeₓSe₃₋ₓ, and combinations thereof, wherein X is an integer in a range of 0-3.

5. The PIC device of embodiment 1, wherein the phase-change material layer comprises Sb₂Se₃.

6. The PIC device of embodiment 1, wherein the substrate comprises an optically transparent material.

7. The PIC device of embodiment 1, wherein the substrate comprises:
an oxidized silicon substrate; and
a Si₃N₄ layer disposed on the oxidized silicon substrate.

8. The PIC device of embodiment 1, wherein the phase-change material further comprises a mixed-phase subregion.

9. The PIC device of embodiment 1, wherein the phase-change material does not comprise a mixed-phase subregion.

10. The PIC device of embodiment 1, wherein the phase-change material layer is one of a plurality of phase-change material layers disposed in a stack of phase-change material layers, and
wherein each phase-change material layer of the plurality of phase-change material layers comprises an amorphous phase subregion and a crystalline phase subregion.

11. The PIC device of embodiment 10, further comprising a cladding material layer disposed between each phase-change material layer of the plurality of phase-change material layers.

12. The PIC device of embodiment 10, wherein at least two adjacent phase-change material layers of the plurality of phase-change material layers are optically coupled.

13. The PIC device of embodiment 10, wherein at least two nonadjacent phase-change material layers of the plurality of phase-change material layers are not optically coupled.

14. The PIC device of embodiment 1, wherein the amorphous phase and crystalline phase define a waveguide optical pathway.

15. A system comprising:
a PIC device comprising:
a substrate;
a phase-change material layer disposed on the substrate, wherein the phase-change material comprises an amorphous phase subregion and a crystalline phase subregion; and
an oxide layer coating the phase-change material layer;
a light source configured to illuminate the PIC device;
a two-dimensional (2D) motion stage, wherein the PIC device is disposed on the 2D motion stage, and wherein the 2D motion stage is configured to move the PIC device relative to the light source; and
a controller operatively coupled to the light source and the 2D motion stage, the controller including logic that, when executed by the controller, causes the system to perform operations comprising:
illuminating, with the light source, the phase-change material layer; and
moving, with the 2D motion stage, the PIC device relative to the light source, thereby selectively inducing a phase transition in the phase-change material layer.

16. The system of embodiment 15, wherein moving, with the 2D motion stage, the PIC device relative to the light source comprises moving the PIC device relative to the light source at a speed in a range of about 0.1 mm/s to about 10 mm/s; and
wherein a power output of the light source is in the range of about 1 mW to about 10 W.

17. The system of embodiment 15, further comprising a heat source configured to apply heat to the PIC device, wherein the controller further includes logic that, when executed by the controller, causes the system to perform operations comprising:
heating, with the heat source, the PIC device at a temperature and for a time sufficient to induce a phase change in the amorphous phase subregion from the amorphous phase to the crystalline phase.

18. The system of embodiment 15, wherein the phase-change material layer is one of a plurality of phase-change material layers disposed in a stack of phase-change material layers, and
wherein each phase-change material layer of the plurality of phase-change material layers comprises an amorphous phase subregion and a crystalline phase subregion.

19. The system of embodiment 18, further comprising a cladding material layer disposed between each phase-change material layer of the plurality of phase-change material layers.

20. The system of embodiment 18, wherein at least two adjacent phase-change material layers of the plurality of phase-change material layers are optically coupled.

21. The system of embodiment 18, wherein at least two nonadjacent phase-change material layers of the plurality of phase-change material layers are not optically coupled.

22. The system of embodiment 18, wherein the controller further comprises logic that, when executed by the controller, causes the system to perform operations comprising:
selectively illuminating a first phase-change material layer of the plurality of phase-change material layers and not a second phase-change material layer of the plurality of phase-change material layers, thereby selectively inducing a phase transition in the first phase-change material layer.

23. The system of embodiment 1, wherein the PIC device further comprises a grating coupler configured to receive light from the light source.

24. A method for writing PICs, the method comprising:
selectively illuminating a PIC device,
wherein the PIC device comprises:
a substrate;
a phase-change material layer disposed on the substrate, wherein the phase-change material comprises a crystalline phase subregion; and
an oxide layer coating the phase-change material layer,
thereby inducing a phase change within the crystalline subregion to generate an amorphous subregion.

25. The method of embodiment 24, wherein the light source has a power output in the range of about 1 mW to about 10 W, and wherein the PIC device is moved relative to the light source at a speed in a range of about 0.1 mm/s to about 10 mm/s.

26. The method of embodiment 24, further comprising erasing photonic integrated circuits by selectively illuminating the PIC device comprising an amorphous phase subregion, thereby inducing a phase change within the amorphous subregion to generate a crystalline subregion.

27. The method of embodiment 24, wherein the phase-change material layer is one of a plurality of phase-change material layers disposed in a stack of phase-change material layers,
wherein the method further comprises selectively illuminating a first phase-change material layer of the plurality of phase-change material layers and not a second phase-change material layer of the plurality of phase-change material layers, thereby selectively inducing a phase transition in the first phase-change material layer.

While illustrative embodiments have been illustrated and described, it will be appreciated that various changes can be made therein without departing from the spirit and scope of the disclosure.

1. A photonic integrated circuit (PIC) device comprising:
a substrate;
a phase-change material layer comprising a phase-change material disposed on the substrate, wherein the phase-change material comprises an amorphous phase subregion and a crystalline phase subregion; and
an oxide layer coating the phase-change material layer.

2. The PIC device of claim 1, wherein the phase-change material is configured to change phases between a crystalline phase and an amorphous phase upon illumination with light.

3. The PIC device of claim 1, wherein the phase-change material layer comprises a low-loss phase-change material layer.

4. The PIC device of claim 1, wherein the phase-change material layer comprises a material selected from the group consisting of Ge₂Sb₂Te₅, Sb₂S₃, Sb₂TeₓSe₃₋ₓ, and combinations thereof, wherein X is an integer in a range of 0-3.

5. The PIC device of claim 1, wherein the phase-change material layer comprises Sb₂Se₃.

6. The PIC device of claim 1, wherein the substrate comprises an optically transparent material.

7. The PIC device of claim 1, wherein the substrate comprises:
an oxidized silicon substrate; and
a Si₃N₄ layer disposed on the oxidized silicon substrate.

8. The PIC device of claim 1, wherein the phase-change material further comprises a mixed-phase subregion.

9. The PIC device of claim 1, wherein the phase-change material does not comprise a mixed-phase subregion.

10. The PIC device of claim 1, wherein the phase-change material layer is one of a plurality of phase-change material layers disposed in a stack of phase-change material layers, and
wherein each phase-change material layer of the plurality of phase-change material layers comprises an amorphous phase subregion and a crystalline phase subregion.

11. The PIC device of claim 10, further comprising a cladding material layer disposed between each phase-change material layer of the plurality of phase-change material layers.

12. The PIC device of claim 10, wherein at least two adjacent phase-change material layers of the plurality of phase-change material layers are optically coupled.

13. The PIC device of claim 10, wherein at least two nonadjacent phase-change material layers of the plurality of phase-change material layers are not optically coupled.

14. The PIC device of claim 1, wherein the amorphous phase and crystalline phase define a waveguide optical pathway.

15. A system comprising:
a PIC device comprising:
a substrate;
a phase-change material layer disposed on the substrate, wherein the phase-change material comprises an amorphous phase subregion and a crystalline phase subregion; and
an oxide layer coating the phase-change material layer;
a light source configured to illuminate the PIC device;
a two-dimensional (2D) motion stage, wherein the PIC device is disposed on the 2D motion stage, and wherein the 2D motion stage is configured to move the PIC device relative to the light source; and
a controller operatively coupled to the light source and the 2D motion stage, the controller including logic that, when executed by the controller, causes the system to perform operations comprising:
illuminating, with the light source, the phase-change material layer; and
moving, with the 2D motion stage, the PIC device relative to the light source, thereby selectively inducing a phase transition in the phase-change material layer.

16. The system of claim 15, wherein moving, with the 2D motion stage, the PIC device relative to the light source comprises moving the PIC device relative to the light source at a speed in a range of about 0.1 mm/s to about 10 mm/s; and
wherein a power output of the light source is in the range of about 1 mW to about 10 W.

17. The system of claim 15, further comprising a heat source configured to apply heat to the PIC device, wherein the controller further includes logic that, when executed by the controller, causes the system to perform operations comprising:
heating, with the heat source, the PIC device at a temperature and for a time sufficient to induce a phase change in the amorphous phase subregion from the amorphous phase to the crystalline phase.

18. The system of claim 15, wherein the phase-change material layer is one of a plurality of phase-change material layers disposed in a stack of phase-change material layers, and
wherein each phase-change material layer of the plurality of phase-change material layers comprises an amorphous phase subregion and a crystalline phase subregion.

19. The system of claim 18, further comprising a cladding material layer disposed between each phase-change material layer of the plurality of phase-change material layers.

20-23. (canceled)

24. A method for writing PICs, the method comprising:
selectively illuminating a PIC device,
wherein the PIC device comprises:
a substrate;
a phase-change material layer disposed on the substrate, wherein the phase-change material comprises a crystalline phase subregion; and
an oxide layer coating the phase-change material layer,
thereby inducing a phase change within the crystalline subregion to generate an amorphous subregion.

25-27. (canceled)
